(19) United States
(12) Patent Application Publication
(10) Pub. No.: US 2018/0000093 A1
(43) Pub. Date: Jan. 4, 2018

(54) SYSTEMS, METHODS AND COMPOSITIONS FOR EFFECTIVE INSECT POPULATION SUPPRESSION

(71) Applicant: EMEKATECH, LLC, Santa Clara, CA (US)

(72) Inventors: Emeka J. NCHEKWUBE, Morgan Hill, CA (US); Cyprian UZOH, San Jose, CA (US)

(21) Appl. No.: 15/542,386

(22) PCT Filed: Jan. 15, 2016
(86) PCT No.: PCT/US16/13727

§ 371 Date: Jul. 7, 2017

Related U.S. Application Data
(60) Provisional application No. 62/104,656, filed on Jan. 16, 2015.

(51) Int. Cl. A01N 63/02; A01M 1/20; A01M 1/10; A01M 1/04; A01M 1/22; A01M 1/02

(52) U.S. Cl. CPC A01N 63/02; A01M 1/226; A01M 1/223; A01M 1/023; A01M 1/106; A01M 1/04; A01M 1/2033

(57) ABSTRACT

Provided herein are compositions, systems, and methods for suppressing a population of insects such as flies. Some embodiments relate to compositions comprising a fermented biomass, a dye and a particulate matter. Some embodiments relate to systems and methods for use of the compositions described herein. The compositions are biodegradable, non-toxic, and environmentally friendly.

### CROSS REFERENCE

This application claims the benefits of U.S. Provisional Application No. 62/104,656, filed Jan. 16, 2015, which is hereby incorporated by reference in its entirety.

### INCORPORATION BY REFERENCE

All publications, patents, and patent applications mentioned in this specification are herein incorporated by reference to the same extent as if each individual publication, patent or patent application was specifically and individually indicated to be incorporated by reference. In particular, the contents of Patent Publication Number WO 2015/013110 A1 filed Jul. 17, 2014, which is hereby incorporated by reference in its entirety.

### BACKGROUND

The house fly, horse fly and other members of their family are not only a nuisance, they are pests at both homes and farms, and often they are laden with disease causing organisms. In developed countries, typically flies arc the most common species found on hog and poultry farms, dairy farms, horse stables and ranches where they are associated with feces and garbage. In developing countries, with poor public hygiene and sanitation that is elementary or less than elementary, the accompanying undesirable very high fly population is a serious public health problem. Fly induced stress and illness is a major source of revenue and energy drain for industrial animal farming operations and the public sector.

Many efforts have been made to suppress fly population in urban and farm settings. Apart from improved public and private sanitation, keeping windows screened and doors closed, sticky traps (fly paper) and ultraviolet light traps (non-chemical control) placed around a home or business also reduce housefly populations. They normally function by electrocuting flies that enter the trap.

In industrial farming operations, for example, in commercial egg production facilities, fly densities are suppressed by the application of insecticides (e.g., adulticides or larvacides) directly or indirectly to where the flies congregate. However, flies develop resistance to commonly used insecticides. For example, fly populations that are subjected to a continuous permethrin regime on industrial farms have rapidly developed resistance to permethrin. Other approach includes treating manure with insecticide; however, this method is highly discouraged as it interferes with biological control of flies, which often results in a rebound of the fly population. Chemical control suppression of fly population has been only partially effective.

### SUMMARY

Disclosed herein are compositions, systems and methods for suppressing insect populations, for example, a fly population.

Some embodiments relate to compositions. Some aspects of these embodiments relate to compositions comprising at least one fermented biomass, at least one dye, and at least one particulate material, wherein the compositions emit at least one volatile material, and wherein the volatile material attracts at least one insect. Volatile materials include, for example, volatile biomass material, volatile fermentation products or other air-borne or olfactorily detectable molecules. In some aspects, the fermented biomass comprises effluent. In some aspects, the fermented biomass comprises a marine biomass. In some aspects, the marine biomass is selected from the group consisting of vertebrates, invertebrates, algae, sponges and corals. In some aspects, the marine biomass comprises fish or mammals. In some aspects, the fermented biomass comprises a biological material obtained from a cephalopod selected from subclasses Coleoidea and Nautiloidea. In some aspects, the cephalopod is selected from the group consisting of squid, cuttlefish, octopus, nautilus and allonautilus. In some aspects, the cephalopod is a squid. In some aspects, the fermented biomass comprises meat or poultry. In some aspects, the fermented biomass comprises skeletal flesh. In some aspects, the fermented biomass comprises a plant biomass. In some aspects, the fermented biomass comprises a protein presence in a decayed biomass. In some aspects, the fermented biomass is subject to at least one of oxygen depletion and carbon dioxide enrichment during fermentation. In some aspects, the fermented biomass is an anaerobic fermentation. In some aspects, fermentation of the biomass is conducted in oxygen depleted environment. In some aspects, fermentation of the biomass is subject to an inert gas enriched fermentation. In some aspects, fermentation of the biomass is subject to a noble gas inert fermentation. In some aspects, fermentation of the biomass completes within at most 10 days. In some aspects, fermentation of the biomass completes within at most 1 day, within at most 2 days, within at most 3 days, within at most 4 days, within at most 5 days, within at most 10 days, within at least 15 days, or within at most 20 days. In some aspects, fermentation of the biomass completes within 1 day, within 2 days, within 3 days, within 4 days, within 5 days, within 10 days, within 15 days, or within 20 days. In some aspects, the fermentation environment is pressurized. In some aspects, the fermentation is conducted in a pressure above 1 atmosphere. In some aspects, the fermentation is conducted in a pressure ranging from 1 atmosphere to 10 atmospheres. In some aspects, the fermentation is conducted in a pressure ranging from 1 atmosphere to 5 atmospheres. In some aspects, the compositions comprise at least one anaerobic bacterium. In some aspects, the anaerobic bacterium occurs in a gut microbiome of an animal intestinal tract. In some aspects, the compositions comprise a bacterium selected from the genus Morganella. In some aspects, the at least one anaerobic bacterium is at least one bacterium selected from the list of bacteria consisting of Morganella morganii and Morganella sibonii. In some aspects, the at least one anaerobic bacterium is Morganella morganii. In some aspects, the at least one anaerobic bacterium is Morganella sibonii. In some aspects, the compositions comprise a bacterium of the tribe Proteeae. In some aspects, the compositions comprise a gram negative bacteria. In some cases, the compositions comprise a gram positive bacteria. In some aspects, the compositions comprise at least one anaerobic bacterium selected from the list consisting of Fusobacterium, Serratia, Enterobacteriaceae, Bacteroides, Photorhabdus, Citrobacter, Peptostreptococcus, Proteus, Peptoniphilus and Vagococcus. In some aspects, the at least one anaerobic bacterium is an obligate anaerobic bacterium. In some aspects, the at least one anaerobic bacterium tolerates oxygen. In another aspects, the at least one anaerobic bacterium is a facultative anaerobic bacterium. In some aspects, the compositions comprise a fungus. In some aspects, the compositions do not comprise a fungus. In some aspects, the dye is visible to the insect, and wherein the insect is attracted to the dye. In some aspects, the dye has an emission wavelength ranging from 200 nanometers to 800 nanometers. In some aspects, the dye has an emission wavelength ranging from 400 nanometers to 600 nanometers. In some aspects, the dye has an emission wavelength near an emission wavelength of ultra violet. In some aspects, the dye is selected from the group consisting of food dye, fluorescein, erythrosine, eosin, carboxyfluorescein, fluorescein isothiocyanate, merbromin, rose bengal, a FD&C Red#40 (E129, Allura Red AC) dye, a FD&C Orange #2 Dye, and a member of the DyLight fluor family. In some aspects, the dye comprises an Erythrosine (FD&C Red#3; E127) dye. In some aspects, the dye is a food dye. In some aspects, the dye comprises a FD&C Red#40 (E129, Allura Red AC) dye. In some aspects, the dye comprises a FD&C Orange #2 Dye. In some aspects, the dye in the composition has a concentration in the range from 0.01 ppm to 1000 ppm of dye on a dry matter basis (weight per weight). In some aspects, the dye is water soluble. In some aspects, the dye is oil soluble. In some aspects, the dye is retard maggot formation. In some aspects, the dye retards at least one stage of maggot formation. In some aspects, the particulate matter comprises at least one metal. In some aspects, the particulate matter comprises at least one inorganic compound. In some aspects, the particulate matter comprises at least one metal and at least one inorganic compound. In some aspects, the particulate matter comprises a clay. In some aspects, the clay is selected from the group consisting of a ball clay, a bentonite clay, a polymer clay, a Edgar plastic kaolin, a silicon powders, a carbon particulates, an activated carbon, a volcanic ash, a kaolinite clays, a montmorillonite, and a treated saw dust. In some aspects, the clay comprises a bentonite clay. In some aspects, the particulate matter comprises titanium dioxide (TiO₂) at an amount of at least 0.1 μg, 0.5 μg, 1.0 μg, 1.5 μg, 2 μg, 5 μg, 10 μg, 20 μg, 100 μg or more. In some aspects, the particulate matter comprises titanium dioxide (TiO₂) at an amount of less than 0.1 μg, 0.5 μg, 1.0 μg, 1.5 μg, 2 μg, 5 μg, 10 μg, 20 μg, or 100 μg. In some aspects, the particulate matter comprises an inorganic matter at an amount of at least 0.1 μg, 0.5 μg, 1.0 μg, 1.5 μg, 2 μg, 5 μg, 10 μg, 20 μg, 100 μg or more. In some aspects, the particulate matter comprises an inorganic matter at an amount of less than 0.1 μg, 0.5 μg, 1.0 μg, 1.5 μg, 2 μg, 5 μg, 10 μg, 20 μg, or 100 μg. In some aspects, the clay comprises titanium dioxide (TiO₂) at an amount of at least 0.5 μg. In some aspects, the clay comprises titanium dioxide (TiO₂) at an amount of at least 0.05 μg. In some aspects, the clay comprises titanium dioxide (TiO₂) at an amount of at least 0.005 μg. In some aspects, the clay comprises titanium dioxide (TiO₂) at an undetectable amount. In some aspects, the clay slows down the amount of volatile material being emitted or evaporated from the composition. In some aspects, the clay slows down the amount of volatile material being emitted or evaporated from the composition by at least 2, 4, 5, 6, 8, 10, 20, 30, 50, 100 or 150 times or more as compared to the composition without the clay. In some aspects, the clay retains the amount of volatile material in the composition. In some aspects, the clay retains the amount of volatile material in the composition by at least 2 times, 4 times, 5 times, 6 times, 8 times, 10 times, 20 times, 30 times, 50 times, 100 times or 150 times or more as compared to a composition without the clay. In some aspects, the clay is in a ratio of at least one gram of clay per five gallons of the fermented biomass. In some aspects, the clay is in a ratio of at least half a gram of clay per five gallons of the fermented biomass. In some aspects, the clay is in a ratio of at least half a gram of clay per 4 gallons, 5 gallons, or 6 gallons of the fermented biomass. In some aspects, the clay is aluminum phyllosilicate clay. In some aspects, the clay comprises Montmorillonite. In some aspects, the clay comprises an aluminum silicate. In some aspects, the clay comprises Al₂O₃4SiO₂H₂O. In some aspects, the clay comprises potassium (K), sodium (Na), calcium (Ca), titanium (Ti) and aluminum (Al). In some aspects, the clay is produced by volcanic ash. In some aspects, the clay is selected from the group consisting of an illite clay, a medicinal clay and a zeolite. In some aspects, the clay is ball clay. In some aspects, the clay comprises kaolinite, mica and quartz. In some aspects, the clay comprises at least 15% kaolinite, at least 8% mica, and at least 4% quartz. In some aspects, the composition attracts an insect from a distance of 50 meters, 100 meters, 200 meters, 300 meters, 400 meters, 500 meters, 600 meters, 700 meters, 800 meters, 900 meters, 1000 meters, 2000 meters, 3000 meters, 4000 meters, 5000 meters or more. In some aspects, the composition attracts the at least one insect from a distance of at least 500 meters. In some aspects, the composition attracts various species of insects. In some aspects, the compositions attract at least one insect selected from the class Pterygota. In some aspects, the compositions attract at least one insect selected from the order Diptera. In some aspects, the at least one insect is a fly. In some aspects, the at least one insect is an ant. In some aspects, the composition attracts at least one insect selected from the group consisting of mayflies, dragonflies, damselflies, stoneflies, whiteflies, fireflies, alderflies, dobsonflies, snake flies, sawflies, caddisflies, butterflies and scorpion flies. In some aspects, the compositions attract insects comprising a pair of flight wings on the mesothorax and a pair of halters, derived from the hind wings, on the metathorax. In some aspects, the at least one insect is at least one insect selected from the group consisting of a black fly, a cluster fly, a crane fly, a robber fly, a moth fly, a fruit fly, a house fly, a horse fly, a deer fly, a face fly, a flesh fly, a green fly, a horn fly, a sand fly, a sparaerocierid fly, a yellow fly, a western cherry fruit fly, a tsetse fly, a cecid fly, a phorid fly, a sciarid fly, a stable fly, a mite, and a gnat. In some aspects, the compositions do not attract an ant, a fruit fly, a bee or a wasp. In some aspects, the compositions do not attract an ant, a fruit fly, a bee or a wasp as efficient as they attract a fly. In some aspects, the compositions attract the at least one insect at a first frequency of at least 50× greater than a second frequency at which the compositions attract at least one bee. In some aspects, the compositions attract at least one insect at least 5 times, 10 times, 20 times, 30 times, 40 times, 50 times, 60 times, 70 times, 80 times, 90 times, 100 times or greater than at which the compositions attract at least the one bee. In some aspects, the compositions attract at least one insect at least 50 times or greater than at which the compositions attract at least the one bee. In some aspects, the compositions attract at least one insect at least by a factor of at least 5, 10, 20, 30, 40, 50, 60, 70, 80, 90, 100 or more than at which the compositions attract at least the one bee. In some aspects, the bee is a bumble bee, a honey bee, a digger bee, a long-horn bee, a carpenter bee, a mining bee, a mason bee, a leafcutter bee, a sweat bee or a polyester bee.

In some aspects, the compositions attract at least one insect over a period of time. In some aspects, the compositions attract an insect for at least one week, two weeks, a month, two months, or more. In some aspects, the compositions attract an insect for at least one week. In some aspects, the compositions attract 3000, 5000, 10000, 20000, 50000, 10000 or more insects in one day.

The fermented biomass disclosed herein is prepared in various forms. In some aspects, the fermented biomass is a liquid. In some aspects, the fermented biomass is a solid. In some aspects, the fermented biomass is a semi-solid. In some aspects, the fermented biomass is a dried fermented biomass. In some aspects, a liquid biomass is air dried, vacuum dried, lyophilized or is treated with any method by which water is removed from the composition. In some aspects, the fermented biomass is placed in an environment that has a moisture content of at least 1, 2, 3, 4, 5, 6, 7, 8, 9, 9.5, 10, 20, 25, 30, 35, 40, 50, 60, 70, 80, 90, 95 or 99.9 weight per weight percent in order to attract the at least one insect. In some aspects, the fermented biomass is placed in an environment having a moisture content of at most 1, 2, 3, 4, 5, 6, 7, 8, 9, 9.5, 10, 20, 25, 30, 35, 40, 50, 60, 70, 80, 90, 95 or 99.9 weight by weight percent in order to attract the one or more insects. In some aspects, the compositions are in semi-solid (i.e. gel) or gas form. In some aspects, the compositions are placed within a gas, solid, liquid or gel. In some aspects, the compositions are placed on or adjacent to a solid, a liquid or a gel. In some aspects, the compositions do not comprise a gel.

Some embodiments relate to compositions that emit at least one volatile material to attract at least one insect. In some aspects, the compositions comprise at least one species of bacterium from the genus Morganella, at least one dye, at least one clay or any other particulate matter, at least one organic matter, and at least one volatile material prevalent in a fermented biomass. In some cases, the compositions do not comprise clay or any other particulate matter. In some cases, the compositions do not comprise a dye. In some aspects, the compositions comprise a photodegradable dye. In some aspect, the compositions comprise a biodegradable dye. In some aspect, the compositions comprise at least one degraded dye. In some aspects, the compositions comprise at least one fragment of a dye. In some cases, a dye that is added to the compositions undergoes molecular degradation into two or more constituent parts or fragments. In some aspects, any of the compositions disclosed herein comprise at least one bacterium selected from the genus Morganella or a bacterium that is present in a fermented biomass, wherein the compositions have an increased frequency of attracting at least one insect by a factor of at least 20 or more, as compared to a composition that does not comprise the at least one bacterium.

Some embodiments relate to systems. Some aspects relate to attracting at least one insect using systems comprising at least one vessel, at least one container, at least one opening to allow escape of a volatile material, at least one inlet, at least one outlet, and at least one composition held in the container, wherein the composition comprises at least one fermented biomass in an oxygen depleted atmosphere, at least one anaerobic bacterium, at least one dye, and at least one clay, wherein the container is held inside the vessel. In some aspects, the systems comprise a vessel, a container, an opening to allow escape of a volatile material, an inlet, an outlet, and a composition held in the container, wherein the composition comprises at least one fermented biomass in an oxygen depleted atmosphere, at least one anaerobic bacterium, at least one dye, and at least one clay, wherein the container is held inside the vessel. Any of the systems disclosed herein comprise at least one composition described herein. In some aspects, the inlet allows the composition to flow into the container. In some aspects, the outlet allows the composition to flow out of the container. In some aspects, the composition flows in and out of the container through the inlet and the outlet. In some aspects, the system comprises an electric mesh surrounding the vessel. In some aspects, the systems comprise a porous radiation resistant layer that separates the vessel from the surrounding environment. In some aspects, the systems comprise an electric control system for receiving operational instructions from a user. In some aspects, the opening prevents the at least one insect from entering into the system. In some aspects, the opening prevents the at least one insect from immediately escaping or traveling through the system. In some aspects, the systems store the composition over a period of time without affecting the efficiency of attracting the at least one insect. In some aspects, the systems store the compositions for at least one week. In some aspects, the systems store the compositions for at least one month. In some aspects, the systems comprise at least one reservoir. In some cases, the reservoir contains any of the compositions disclosed herein. In some cases, the reservoir contains an aqueous solution. In some cases, the reservoir contains a solution for cleaning the systems. In some aspects, the system comprises at least one sensor selected from the group consisting of a pH sensor, a light sensor, a visual sensor, a conductivity sensor, a turbidity sensor, a viscosity sensor, a pressure sensor, an oxygen sensor, a carbon dioxide sensor, a humidity sensor, a displacement sensor, a proximity sensor and temperature sensor. In some cases, the sensor is a visual sensor. In some cases, the sensor is sensitive to infra-red radiation, ultra violet radiation or to the visual spectrum of a human. In some cases, the sensor is sensitive to ultra violet radiation. In some aspects, the systems allow a fluid or any of the compositions disclosed herein from the container to be released out of the outlet, based on an input from a user, or based on a sensor signal, or based on pre-programmed instructions. In some aspects, the systems allow a fluid or any of the compositions disclosed herein from the reservoir to flow into the container, based on an input from a user, or based on a sensor signal, or based on pre-programmed instructions. In some aspects, the user controls the relative position of an individual vessel in the systems. In some aspects, the user controls at least 1, 2, 3, 4, 5, 6, 7, 8, 9, 10, or more vessels simultaneously. In some aspects, the systems comprise a control system. In some aspects, the control system is an operation system. In some aspects, the operation system comprises a micro-processor. In some cases, the micro-processor is connected to the systems directly or remotely. In some cases, the user accesses the control system directly. In some cases, the user accesses the control system remotely. In some cases, the user accesses the control system through the internet. In some cases, the systems operate without human intervention for at least 1 month, 2 months, 3 months, 4 months, 5 months, 6 months, 7 months, 8 months, 9 months, 10 months, 1 year, 2 years, 3 years, 4 years, 5 years, 6 years, 7 years, 8 years, 9 years, 10 years, or longer. In some aspects, the systems comprise an electric mesh, wherein the electric mesh conducts a current that startles the insect, temporarily shocks the insect and render it unable to fly, maims or kills the insect. In some cases, the electric mesh conducts a current of at least 500 Volts (V) in direct current (DC) or alternate current (AC) current. In some cases, the electric mesh conducts a current of at most 1500 Volts (V) in direct current (DC) or alternate current (AC) current. In some cases, the electric mesh conducts a current between 500 Volts (V) to 1500 Volts (V) in direct current (DC) or alternate current (AC) current. In some cases, the electric mesh conducts a current of at least 250 Volts (V) in DC or AC current. In some cases, the electric mesh conducts a current of at 2000 V in direct current (DC) or alternate current (AC). In some aspects, an insulation mesh is included to surround the electric mesh to prevent non insect animals such as a bird from getting injured by the electric mesh, e.g. being shocked by the electric mesh. In some aspects, the systems comprise a wiper to remove debris from the electric mesh. In various cases, the debris is a dead insect, a shocked insect, an immobilized insect, a dirt, or dust. In some cases, the wiper is controlled by the control system. In some cases, the current in the electric mesh is controlled by the control system. In some cases, the wiper wipes against the electric mesh to remove or dislodge insect material from the electric mesh. In some cases, the wiper comprises a movable brush. In some cases, the wiper is operated at a predetermined time. In some cases, the wiper is controlled manually, mechanically or by a control system disclosed herein or any control system known in the art. In some aspects, the systems comprise a reservoir or a chamber for collecting dead, startled, shocked, or maimed insects. In some aspects, the systems comprise a treatment vessel in which the insects in the vessel are subject to at least one treatment. In some cases, the treatment comprises preserving the insects. In some cases, the treatment comprises disintegrating the insects. In some cases, the disintegrating treatment is selected from heat treatment, lyphilization (freeze drying), acid treatment, base treatment, composting, or mechanical shearing. In some cases, the treatment comprises decreasing an amount of odor emitted from the insects. In some cases, the decreasing an amount of odor emitted from the insects comprising treating the insects with chlorine, alcohol, wax or oil. In some cases, the treatment comprises placing the insects in a preserving liquid, e.g. formaldehyde, formalin, wax or oil. In some aspects, the systems attract at least 1000, 2000, 3000, 5000, 10000, 20000, 50000, 10000 or more insects in a day, a week, a month, or 1 year. In some aspects, the systems attract at least 1000, 2000, 3000, 5000, 10000, 20000, 50000, 10000 or more insects in a day. In some aspects, the systems comprise an opening that is guarded by a porous radiation resistant layer disclosed herein. In some cases, the porous radiation resistant layer is directly attached to the opening through which the volatile material escapes to the surrounding environment. In some case, the porous radiation resistant layer covers the opening completely or partially.

Any of the systems disclosed herein comprise at least one of the compositions disclosed herein.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures.

FIG. 1 illustrates a population of bacteria comprising multiple bacterial species in an insect attractant under varied conditions.

FIG. 2 illustrates a portion of a population of individual bacterial species in a population of bacteria comprising multiple bacterial species in an insect attractant under varied conditions.

FIG. 3 illustrates a percentage of a population of an individual bacterial species in an insect attractant comprising multiple bacterial species under varied conditions.

FIG. 4 depicts a system illustrating an insect trapping apparatus with insect collection and flushing system.

FIG. 5 depicts a system illustrating an insect trapping apparatus with insect collection and flushing system with conical fly entrance.

FIG. 6 illustrates a scaled up industrial system with automatic insect collection station and flushing system.

FIG. 7 illustrates the configuration of a pest management systems with fan and powered electrical mesh.

FIG. 8 illustrates a compact pest management system with a reservoir for attractant and a substrate housing.

FIG. 9 illustrates the configuration of a pest management system with powered electrical mesh.

FIG. 10 illustrates the configuration of a compact apparatus with capillary action delivery for pest management.

FIG. 11 illustrates the configuration of a compact apparatus with attractant fluid for pest management.

FIG. 12 illustrates a system with an array of electrical grid insect suppression system.

FIG. 13 illustrates a microwave pest ablation system.

FIG. 14 illustrates a system comprising an electric mesh or porous radiation resistant layer surround a porous vessel that contains an insect attractant.

FIG. 15 illustrates a system comprising a brush cleaner arrangement for cleaning the electric mesh layer outside the vessel that contains an insect attractant.

FIG. 16 depicts a computer system for pre-programmed automatic machine operation of the disclosed systems.

### DETAILED DESCRIPTION

Disclosed herein are highly effective and efficient compositions, systems and methods for suppressing varies species of insects. The compositions, systems and methods disclosed herein are achieved by utilizing compositions comprising a fermented biomass, a dye, and a particulate matter, wherein the compositions emanate vapors to attract at least one insect. The compositions, systems and methods disclosed herein do not result in insecticide resistance, are biodegradable, non-toxic, and ecologically friendly.

The disclosed compositions and methods enable one to attract, maim, startle, kill, or suppress the flight or population numbers of various species of insects, in some cases selectively excluding beneficial insects such as bees from the killing or population suppression. In some cases, the biomass is any organic matter prepared from organisms from a terrestrial or an aquatic habitat, examples of which include but not limited to, vertebrates, invertebrates, plants, sponges, corals, algae, or planktons. As another non-limiting example, the biomass is a terrestrial biomass or a marine biomass. In some cases, the biomass is produced from a living organism, a dead organism or a decayed protein from at least one organism.

The disclosed compositions comprise at least one attractant to lure at least one insect. The term “composition” is used interchangeably in some cases herein with the term “attractant”. The compositions are largely or completely biodegradable, non-toxic and ecologically friendly. In some cases, the compositions are synthesized from organic materials. In some cases, the compositions exhibit low toxicity to animals or livestock, for example, horse, cattle birds, and chicken. The waste byproducts of the compositions are environmentally non-toxic that they are compostable. In some cases, the waste byproducts of the compositions are applied as fertilizers, or food for some other animals such as fish, cattle, poultry, pigs or birds. The compositions are substantially free of synthetic pesticides. For example, the compositions comprise an amount of synthetic pesticides at or below the maximum level that is approved by the FDA as safe for humans.

The compositions, systems, and methods disclosed herein are effective for suppression of pest insect species. Pest insect species are, for example, at least one species of insects within the insect subclass Pterygota. Pterygota includes the winged insects and insect orders that are secondarily wingless (for example, insect groups whose ancestors once had wings but that have lost them as a result of subsequent evolution). Non-limiting examples of Pterygota are cockroaches and termites, butterflies, moths, fleas, and true flies. In some cases the device selectively excludes butterflies. The compositions, systems, and methods described herein are configured to effectively attract, kill, or suppress one or more species of true flies or flies of the order Diptera. The insects being attracted by the present disclosure in some cases are selected from the Diptera families of Nematocera or Brachycera. The insect in these phyla have a pair of flight wings on the mesothorax and a pair of halters, derived from the hind wings, on the metathorax.

The disclosed compositions, systems, and methods effectively attract, trap, maim, startle, kill or suppress the flight of an insect, e.g. a fly, or suppress the populations of an insect, e.g. a fly. In some cases, the fly is selected from the group consisting of a black fly, a cluster fly, a crane fly, a robber fly, a moth fly, a fruit fly, a house fly, a horse fly, a deer fly, a face fly, a flesh fly, a green fly, a horn fly, a sand fly, a sparaerocierid fly, a yellow fly, a western cherry fruit fly, a tsetse fly, a cecid fly, a phorid fly, a sciarid fly, a stable fly, a mite, and a gnat. In some cases, the disclosed compositions, systems, and methods are effective for suppression of house and horse flies. In some cases, the disclosed compositions, systems, and methods are modified to trap tsetse fly. It is noted that the flies are one of the many examples that are effectively attracted, trapped, maimed, startled, killed or flight-suppressed by the present compositions, systems, and methods. For example, the disclosed compositions, systems, and methods are effective for suppression of tiny insects including mosquitoes. As another example, the disclosed compositions, systems, and methods are effective for suppression of organisms such as ants. In some cases, the disclosed compositions, systems, and methods are effective for pest control.

The compositions, systems, and methods described herein exhibit selectivity in attracting, trapping, maiming, startling, killing, suppressing the flight of insects, or suppressing an insect population of at least one insect species. In some cases, the selectivity is gender selective. For example, in some cases only males or only females of at least one insect species are attracted. In alternate examples both males and females are attracted. In some cases, the attractant has a very high affinity for the females of a species. In some cases, the attractant has a very high affinity for the males of a species.

In some cases, the selectivity is species selective. For example, the compositions, systems, and methods described herein are configured to attract, trap, maim, startle, kill, suppress the flight of or suppress the population of one or more first insect species at a higher frequency than one or more second insect species. For example, the compositions, systems, and methods disclosed herein are effective for selectively suppressing a population of house fly or horse fly. In some cases, the first insect species is a horse fly. In some cases, the first insect species is a house fly. In some cases, the second insect species is in the phylum Apis. In various cases, the second insect species is a beneficial insect. In some cases the second insect species is selected from the group consisting of grasshoppers, dragonflies, wasps, butterflies, moths, and beetles. In some cases, the compositions, systems, and methods do not attract bees (e.g. honeybees).

In various cases, the compositions comprise organic materials or effluent from animal flesh from a terrestrial animal, an aquatic animal, a vertebrate, or an invertebrate. In some cases, the organic materials come from a live animal, a dead animal or a corpse, a debris or decayed protein of an animal or a plant, wherein these organic materials are used alone or in combinations. In some cases, the compositions comprise a biomass material obtained from an animal, a plant source, or both. In some cases, the biomass material is an aquatic biomass, a terrestrial biomass, or both. In some cases, the biomass material is an industrial or a non-industrial biomass. In some cases, to further reduce cost and to improve effectiveness of producing the compositions, the biomass material is obtained from at least one biomass waste. The biomass waste comprises visceral parts, somatic parts, excretions, and manure of an animal. In some cases, the biomass waste comes from more than one animal, or more than one plant. In some cases, the biomass waste comes from more than one species of animal, or more than one species of plant.

The biomass for use in the compositions disclosed herein is often obtained from an animal. For example, the animal biomass includes but is not limited to, a terrestrial biomass such as a slaughterhouse waste, a food and a non-food waste, a poultry processing plant waste, a swine processing waste, a dead stock, a spoiled meat, and a spoiled poultry. In other examples, the animal biomass is obtained from a marine animal, a freshwater animal, a fish flotsam, a vertebrate or an invertebrate marine animal, or any combinations thereof. For example molluscs such as cephalopods from the subclass Coleoidea or Nautiloidea, gastropod, bivalve species are used as a precursor material. In some cases, the cephalopod is a squid. In some cases, at least one cuttlefish, mussel, octopus, squid, is used alone or in combination with at least one clam, oyster, scallop, mussel, snail, slug and their likes as a precursor material for making the compositions. In some cases, a fresh water biomass, a marine biomass, a plant biomass, and an animal biomass, alone or in combinations, is used to produce the compositions described herein. In various examples, marine fish or freshwater fish are used alone or in combination with invertebrates from the phylum Mollusca.

In some cases, terrestrial plants and aquatic organisms are used as a precursor material for producing the compositions disclosed herein. For example, terrestrial plants such castor oil seed (Ricinus communis) or African oil bean seed (Pentaclethra macrophylla) is boiled and fermented as an attractant. The fermented and unfermented seeds are combined in appropriate proportions. In another example, aquatic organisms such as sponges, corals or algae are used as a precursor material. Examples of aquatic organisms for producing the compositions disclosed herein include kelp or other algae. The fermented and unfermented kelp or other algae is combined in appropriate proportions as a precursor material. In some cases, waste materials are used as a precursor material for producing the compositions disclosed herein. For example, waste materials are obtained from a fish market, a fish farm, a restaurant, a dumpster, or any other sources where fish waste materials are disposed. The fish waste suitable for use includes both marine and freshwater animals, including vertebrates and invertebrates. The precursor material is formed by one type of fish waste or by combinations of fish waste from different sources.

In any of the cases described herein, any of the precursor materials described herein do not require further processing and are ready for use in compositions to attract at least one insect.

In some cases, the compositions comprise a fermented aquatic biomass. In one example, the aquatic biomass comprises an aquatic plant, a marine plant, or a fresh water plant. For example, the marine biomass is selected from a sponge, a coral, and an alga. Regardless of the nature and method or the processing of the attractant, the effluent material (whether liquid, solid or semi-solid) or solids from an anaerobic reaction is collected and used as an attractant.

In some cases, the biomass consists of or comprises effluent, such as liquid waste or discharge form a terrestrial or a marine animal, for example a squid. The effluent is used alone or, alternately, is combined with various agents that are known in the art to attract insects (e.g. those that are deployed in a trapping or an attracting apparatus).

The biological material is fermented in many cases prior to use as an animal attractant. In some cases, the compositions comprise fermentation products of a marine biomass or a freshwater biomass disposed in an apparatus, a system, or a container. The term “apparatus” and the term “system” are interchangeably used herein and refer to a device that contains any of the compositions described herein to attract at least one insect. In some cases, the attractant of this disclosure is deployed in an apparatus with a modified cover; and the various insects of interest, e.g. flies, are attracted to enter the container. Without being bound by any theory, the trapped insects, e.g. flies, are overwhelmed by the attractant and exhibit no inclination to escape from the apparatus. The attracted flies die from drowning, starvation, or from compounds emanating from the attractant. In some examples, most insects, e.g. flies, do not escape from the container.

In some examples, none of the attracted insects, e.g. flies, escapes from the container. The attracted insects, e.g. flies, are killed by an electric mesh or a microwave layer enclosing the attractant, wherein the insects do not have contact with the attractant. In some cases, the attracted insects, e.g. flies, die and form a layered structure over the attractant. The dead fly structure forms an anaerobic seal and a substrate over the attractant to create a self-propagating anaerobic system. The specific insect “fly” is used herein as one example for an insect, and thus the disclosure should not necessarily be limited to “fly” in all cases.

In some aspects, the compositions comprise fermented organic matter obtained from any of the biomasses described herein. Fermentation is accomplished prior to formulation of the composition or, alternately, concomitant with composition formulation. As discussed above, in some instances fermentation occurs in a container for which an anaerobic environment has been generated through accumulation of a layer of dead insects.

Fermentation of the biomass is enhanced by the addition of at least one species of anaerobic bacteria to the compositions. Typically, the bacteria are obligatory anaerobic, facultative anaerobic, or anaerobic bacteria that may tolerate oxygen. The at least one bacterium is selected from a group of bacteria that occur in a gut microbiome of an animal gastrointestinal tract. Examples of bacteria for enhancing fermentation include, but are not limited to, Fusobacterium, Serratia, Enterobacteriaceae, Bacteroides, Photorhabdus, Citrobacter, Peptostreptococcus, Proteus, Peptoniphilus and Vagococcus. In some cases, the at least one bacterium is gram negative. In some cases, at least one bacterium is gram positive bacteria. In some cases, at least one bacterium is from the tribe Proteeae within the bacterial family Enterobacteriaceae including Proteus, Morganella and Providencia. In some cases, at least one bacterium is from the genus Morganella including Morganella morganii and Morganella sibonii.

Fermenting bacteria are added to the biomass either prior to, concomitant with or subsequent to formulation of the composition. In some cases no bacteria are added, because they are already present in the starting material of the biomass, such as the effluent. In some cases, the odor producing bacteria are cultured bacteria. The cultured bacteria are blended with the biomass and the mixture is let to ferment for a period of time sufficient to achieve fermentation. The cultured bacteria are selected from a group of bacteria that occur in a gut microbiome of an animal gastrointestinal tract. Examples of cultured bacteria for deployment as attractant in a fluid or gel or semi-solid or solid or combination thereof, but are not limited to, Fusobacterium, Serratia, Enterobacteriaceae, Bacteroides, Photorhabdus, Citrobacter, Peptostreptococcus, Proteus, Peptoniphilus and Vagococcus. In some cases, the at least one cultured bacteria are gram negative. In some cases, at least one cultured bacteria are gram positive bacteria. In some cases, at least one cultured bacterium is selected from the tribe Proteeae within the bacterial family Enterobacteriaceae including Proteus, Morganella and Providencia. In some cases, at least one cultured bacterium is selected from the genus Morganella including Morganella morganii and Morganella sibonii.

In some cases, fermentation of the biomass for use as an insect attractant disclosed herein comprises adding one or more species of bacteria to the biomass including a terrestrial or an aquatic animal flesh, a plant or a marine organism such as corals, sponges and algae. The proportion of bacteria to the biomass varies and in some cases determines the effectiveness of the insect attractant. The percentage of a bacterium to the total population of bacteria ranges in various cases from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases the percentage of a bacterium to the total population of bacteria is at most 0.001%, 0.01%, 0.05%, 1%, 2%, 3%, 4%, 5%, 6%, 8%, 9%, 10%, 12%, 15%, 20%, 25%, 30%, 35%, 40%, 45%, 5%, 60%, 70%, 80%, 90%, 95%, 99%, or 99.9%. In some cases the percentage of a bacterium to the total population of bacteria is at least 0.001%, 0.01%, 0.05%, 1%, 2%, 3%, 4%, 5%, 6%, 8%, 9%, 10%, 12%, 15%, 20%, 25%, 30%, 35%, 40%, 45%, 5%, 60%, 70%, 80%, 90%, 95%, 99%, or 99.9%.

As a non-limiting example, the percentage of Fusobacterium to the total population of bacteria added for enhancing a fermentation biomass for the use in this disclosure ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the percentage of Fusobacterium to the total population of bacteria ranges from 0.01% to 45%, 0.05% to 2.5%, or 0.2% to 20%. In some cases, the percentage of Fusobacterium to the total population of bacteria added for enhancing a fermentation biomass is equal to or less than 2.5%. In some cases, the percentage of Fusobacterium to the total population of bacteria added for enhancing a fermentation biomass is equal to or less than 0.1%. In some cases, the percentage of Fusobacterium to the total population of bacteria added for enhancing a fermentation biomass for the use in this disclosure is equal to or greater than 0.01%. In some cases, the percentage of Fusobacterium to the total population of bacteria added for enhancing a fermentation biomass is equal to or greater than 1%.

As another non-limiting example, the percentage of Serratia to the total population of bacteria added for enhancing a fermentation biomass ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the percentage of Serratia to the total population of bacteria added for enhancing a fermentation biomass ranges from 0.01% to 45%, 5% to 40%, 8% to 12%, or 1% to 10%. In some cases, the percentage of Serratia to the total population of bacteria added for enhancing a fermentation biomass is equal to or less than about 40%. In some cases, the percentage of Serratia to the total population of bacteria added for enhancing a fermentation biomass is equal to or less than 15%. In some cases, the percentage of Serratia to the total population of bacteria added for enhancing a fermentation biomass for the use in this disclosure is equal to or less than 12%. In some cases, the percentage of Serratia to the total population of bacteria added for enhancing a fermentation biomass for the use in this disclosure is equal to or greater than 8%. In some cases, the percentage of Serratia to the total population of bacteria added for enhancing a fermentation biomass is equal to or greater than 8%.

As yet another non-limiting example, the percentage of Enterobacteriaceae to the total population of bacteria added for enhancing a fermentation biomass ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the percentage of Enterobacteriaceae to the total population of bacteria added for enhancing a fermentation biomass ranges from 0.01% to 45%, 1% to 5%, 2% to 10%, 8% to 15%, 10% to 20%, or 2% to 35%. In some cases, the percentage of Enterobacteriaceae to the total population of bacteria added for enhancing a fermentation biomass is equal to or less than 40%. In some cases, the percentage of Enterobacteriaceae to the total population of bacteria added for enhancing a fermentation biomass is equal to or greater than 25%.

In another non-limiting example, the percentage of Bacteroides to the total population of bacteria added for enhancing a fermentation biomass ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the percentage of Bacteroides to the total population of bacteria added for enhancing a fermentation biomass ranges from 0.01% to 45%, 0.1% to 2%, 2% to 5%, 3% to 12%, 4% to 5%, or 10% to 40%. In some cases, the percentage of Bacteroides to the total population of bacteria added for enhancing a fermentation biomass is equal to or less than 40%. In some cases, the percentage of Bacteroides to the total population of bacteria added for enhancing a fermentation biomass is equal to or less than 5%. In some cases, the percentage of Bacteroides to the total population of bacteria added for enhancing a fermentation biomass is equal to or greater than 1%. In some cases, the percentage of Bacteroides to the total population of bacteria added for enhancing a fermentation biomass is equal to or greater than 4%.

In one example, the percentage of Morganella to the total population of bacteria added for enhancing a fermentation biomass ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the percentage of Morganella to the total population of bacteria added for enhancing a fermentation biomass ranges from 0.01% to 45%, 0.02% to 5%, 0.1% to 30%, 1% to 10%, 5% to 25%, or 10% to 40%. In some cases, the percentage of Morganella to the total population of bacteria added for enhancing a fermentation biomass is equal to or less than 5%. In some cases, the percentage of Morganella to the total population of bacteria added for enhancing a fermentation biomass is equal to or greater than a 0.05%. In some cases, the percentage of Morganella to the total population of bacteria added for enhancing a fermentation biomass is equal to or greater than 0.01%.

In another example, the percentage of Photorhabdus to the total population of bacteria added for enhancing a fermentation biomass ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the percentage of Photorhabdus to the total population of bacteria added for enhancing a fermentation biomass ranges from 0.01% to 45%, 0.02% to 0.04%, 0.05% to 15%, 0.1% to 30%, 1% to 10%, 2% to 35%, 5% to 25%, 12% to 20%, or 25% to 40%. In some cases, the percentage of Photorhabdus to the total population of bacteria added for enhancing a fermentation biomass is equal to or less than 20%. In some cases, the percentage of Photorhabdus to the total population of bacteria added for enhancing a fermentation biomass is equal to or less than 1%. In some cases, the percentage of Photorhabdus to the total population of bacteria added for enhancing a fermentation biomass is equal to or greater than 15%. In some cases, the percentage of Photorhabdus to the total population of bacteria added for enhancing a fermentation biomass is equal to or greater than 0.5%.

In yet another example, the percentage of Citrobacter to the total population of bacteria added for enhancing a fermentation biomass ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the he percentage of Citrobacter to the total population of bacteria added for enhancing a fermentation biomass ranges from 0.01% to 45%, 0.02% to 0.05%, 0.1% to 30%, 0.5% to 20%, 1% to 10%, 2% to 15%, 5% to 25%, 12% to 30%, or 25% to 40%. In some cases, the percentage of Citrobacter to the total population of bacteria added for enhancing a fermentation biomass is equal to or less than 25%. In some cases, the percentage of Citrobacter to the total population of bacteria added for enhancing a fermentation biomass is equal to or less than 5%. In some cases, the he percentage of Citrobacter to the total population of bacteria added for enhancing a fermentation biomass is equal to or greater than 0.5%. In some cases, the he percentage of Citrobacter to the total population of bacteria added for enhancing a fermentation biomass is equal to or greater than 20%.

In yet another example, the percentage of Peptostreptococcus to the total population of bacteria added for enhancing a fermentation biomass ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the percentage of Peptostreptococcus to the total population of bacteria added for enhancing a fermentation biomass ranges from 0.01% to 45%, 0.02% to 0.05%, 0.1% to 5%, 0.2% to 30%, 1% to 10%, 2% to 15%, 5% to 25%, 12% to 20%, or 25% to 40%. In some cases, the percentage of Peptostreptococcus to the total population of bacteria added for enhancing a fermentation biomass is equal to or less than 15%. In some cases, the percentage of Peptostreptococcus to the total population of bacteria added for enhancing a fermentation biomass is equal to or less than 5%. In some cases, the percentage of Peptostreptococcus to the total population of bacteria added for enhancing a fermentation biomass is equal to or greater than 0.1%.

In yet another example, the percentage of Proteus to the total population of bacteria added for enhancing a fermentation biomass ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the percentage of Proteus to the total population of bacteria added for enhancing a fermentation biomass ranges from 0.01% to 45%, 0.01% to 1.2%, 0.02% to 0.05%, 0.2% to 30%, 1% to 10%, 2% to 15%, 5% to 25%, 12% to 20%, or 25% to 40%. In some cases, the percentage of Proteus to the total population of bacteria added for enhancing a fermentation biomass is equal to or less than 10%. In some cases, the percentage of Proteus to the total population of bacteria added for enhancing a fermentation biomass is equal to or less than 1%. In some cases, the percentage of Proteus to the total population of bacteria added for enhancing a fermentation biomass is equal to or greater than 0.01%.

In yet another example, the percentage of Vagococcus to the total population of bacteria added for enhancing a fermentation biomass ranges from 0.001% to 50%, 0.05% to 1%, 0.1% to 5%, 2% to 10%, 3% to 15%, 4% to 20%, 6% to 25%, 8% to 30%, 12% to 35%, 16% to 40%, 18% to 45%, 10% to 100%, 20% to 80%, 30% to 50%, 40% to 60%, or 50% to 90%. In some cases, the percentage of Vagococcus to the total population of bacteria added for enhancing a fermentation biomass ranges from 0.01% to 45%, 0.02% to 0.05%, 0.04% to 1.2%, 0.1% to 30%, 1% to 10%, 2% to 15%, 5% to 25%, 12% to 20%, or 25% to 40%. In some cases, the percentage of Vagococcus to the total population of bacteria added for enhancing a fermentation biomass is equal to or less than 10%. In some cases, the percentage of Vagococcus to the total population of bacteria added for enhancing a fermentation biomass is equal to or less than 1%. In some cases, the percentage of Vagococcus to the total population of bacteria added for enhancing a fermentation biomass is equal to or less than 0.05%. In some cases, the cultured bacteria are blended with fermented bacteria. In some cases, aerobically cultured bacteria are blended with anaerobically fermented bacteria.

In some cases, a combination of the percentages of Citrobacter and Photorhabdus to the total population of bacteria in the deployed fermented biomass is equal to or greater than 25%. In some cases, a combination of the percentages of Citrobacter, Photorhabdus, Enterobacteriaceae, Proteus, Morganella and Providencia to the total population of bacteria in the deployed fermented biomass is equal to or greater than 50%.

In some cases, a combination of the percentages of Bacteroides, Enterobacteriaceae and Serratia to the total population of bacteria in the deployed fermented biomass is equal to or greater than 50%. In some cases, a combination of the percentages of Bacteroides, Enterobacteriaceae, Serratia and Fusobacterium to the total population of bacteria in the deployed fermented biomass is equal to or greater than 50%.

In some cases, the combination of the percentage of Citrobacter and Photorhabdus, Enterobacteriaceae including Proteus, Morganella and Providencia and Serratia to the total population of bacteria in the deployed fermented biomass is equal to or greater than 60%. In some cases, the combination of the percentage of Bacteroides with Enterobacteriaceae to the total population of bacteria in the deployed fermented biomass is equal to or greater than 40%.

The fermentation reaction is processed in anaerobic ambient. In some cases, the anaerobic ambient comprises carbon dioxide, inert gases and hydrogen. In some cases, the hydrogen composition in the gas mixture is kept below 50%, 40% 30%, 20%, 10%, 5%, 2%, or 1% to reduce the potential of explosion and fire.

In some cases, the reaction chamber for fermentation is recharged with more anaerobic fluids at the apportioned intervals. The water used for the fermentation step is de-oxygenated, for example, using hollow fiber gas removal methods. In some cases, the various gases in the water is removed prior to the incorporation of carbon dioxide or known inert gases in the reaction vessel.

Fermentation of the biomass for use in this disclosure comprises incubating at least one organic matter, and at least one species of anaerobic bacteria in a container under substantially anaerobic conditions as described herein. Optionally, at least one dye, at least one clay, or both are added prior to, during or after the fermentation.

In one example, fermentation of the biomass is completed in 1 to 100 days, 2 to 10 days, 5 to 15 days, 10 to 20 days, 50 to 100 days, or 150 to 180 days. In one example, fermentation of the biomass is completed within about 1 day, 2 days, 5 days, 10 days, 15 days, 20 days, 50 days, or more. In some cases, fermentation of the biomass completes within at most at most 50 days, 20 days, 15 days, 10 days, 5 days, 2 days, or 1 day. In some examples, fermentation of the biomass is completed within 10 days.

Materials produced by the anaerobic action in attractant diffuse through the dead fly layer or structure into the external ambient to attract more flies thereby creating a self-propagating open system. The thickness of the anaerobic seal increases while more dead flies accumulate in the layer. The thickness of the anaerobic seal varies and ranges from 0.5 centimeter (cm) to over 1000 centimeters (cm). The thickness of the anaerobic seal is in some cases about 0.5 cm, 1.0 cm, 5 cm, 10 cm, 20 cm, 50 cm, 100 cm, 150 cm, 200 cm, 300 cm, 500 cm, 800 cm, 1000 cm or more.

The compositions disclosed herein are prepared in various forms. In some aspects, the compositions are provided in solid form, liquid form or semi-solid form. For example, some of the compositions are in the form of a gel. In some aspects, the compositions comprise a fermented biomass in solid, liquid or semi-solid form.

Fermentation of the biomass is enhanced by addition of at least one bacterium to the compositions. Typically, the bacterium is a type of anaerobic bacterium such as an obligatory anaerobic bacterium, a facultative anaerobic bacterium, or an anaerobic bacterium that tolerates oxygen. In some cases, fermentation of the biomass is conducted in a low oxygen environment. For example, fermentation of the biomass of the present composition is produced under an anaerobic condition, a substantially anaerobic condition, a carbon dioxide enriched condition, or an oxygen-depleted condition. In some cases, fermentation of the biomass of the present compositions is an anaerobic fermentation.

Further disclosed herein are compositions that emit signals to attract at least one insect. In some cases, the compositions comprise effluent. In some cases, the compositions emit at least one volatile material to attract insects. In some cases, the compositions emit visible signals to attract insects. Non-limiting examples of visible signals include light, color, or wavelength. In some cases, the composition comprises at least one dye that emits visible attraction to an insect, e.g. a fly. In further cases, the dye suppresses maggot formation.

In some embodiments, the compositions are stored in systems comprising at least a vessel, a container, an inlet, an outlet, wherein the compositions are stored in the container. In some cases, the container resides inside the vessel. The compositions and systems emit volatile materials to attract at least one insect. In some cases, the attracted insects are trapped, killed or suppressed inside the systems, wherein the systems further comprise a compartment for cleaning the trapped, killed or suppressed insects. In various cases, the compartment is a reservoir, a vessel, a container, or a chamber. In some aspects, the systems comprise an aqueous flushing system for cleaning the trapped, killed or suppressed insects. The flushing system is operated manually or controlled by pre-programmed instructions. In some aspects, the systems comprise an electric mesh for killing, maiming, startling the attracted insects to render them unable to fly, wherein the attracted insects do not enter the systems. Parts, corpses or debris of the insects on the electric mesh is cleaned by a wiper, or blown away by wind. In some cases, the wiper contains a brush. In some cases, the systems comprise a microwave resistance porous layer for momentarily zapping or killing the attracted insects with microwave beam or radiation. The zapping and killing is preset at regular intervals that are predetermined, responding to a sensor, responding to a control system, or responding to a user input. In some aspects, the systems comprise a collector for collecting the insects.

Disclosed herein is also a method of stabilizing the attractant composition and increasing the shelf life of the composition and the time by which it is able to attract insects. For example, one or more types of clay are added to the fermented composition for this purpose.

The systems disclosed herein are capable of attracting, trapping, maiming, startling, killing or suppressing the flight of insects. As an example, the number of insects being attracted, trapped, maimed, startled, killed or flight-suppressed by the present system and systems ranges from about 1 to 500 insects, 1000 to 10000 insects, 3000 to 50000 insects, 2000 to 10000 insects, 8000 to 90000 insects, 5000 to 20000 insects, in one day. In some cases, the number of insects being attracted, killed, or suppressed by the present system and systems is from at least 10 insects, 100 insects, 1000 insects, 2000 insects, 3000 insects, 5000 insects, 10000 insects, 20000 insects, 50000 insects, 100000 insects, 1000000 insects, or more insects in one day.

Disclosed herein are methods of enhancing the compositions in attracting insects, for example, at least one dye that emits light is added to the compositions. In some cases, the compositions is do not comprise a dye (i.e. dye free). Typically, the dye emits light that increases the attraction of insects. The dye is relatively inexpensive, exhibits low toxicity to humans and animals, and is for disposal after deployment. In some cases, the compositions (i.e. attractant) comprise a single dye, or a combination of several dyes. In some cases, the compositions comprise a fluorophore or fluorescent dye. The dye is selected from edible dye, injectable dye, parenteral dye, nontoxic dye and biodegradable dye. In some cases, the compositions comprise at least one fluorescing ultra-violet dye, or a dye that fluoresces within visible (to humans, or to insects) or non-visible spectrum of light. In some cases, the fluorescent dye is hydrophilic. In some cases, the fluorescent dye is hydrophobic. The dye is water soluble. The dye is added to the precursor material in various steps during production of the compositions. For example, the dye is added prior to the fermentation step, during the fermentation step, subsequent to the fermentation step, or in any combination thereof. In some cases, the dye is incorporated into the attractant post fermentation. In some aspects, the compositions comprise a photodegradable dye. In some aspects, the compositions comprise a biodegradable dye. In some aspects, the compositions comprise at least one degraded dye or fragments of a dye. In some cases, the compositions comprise degraded dyes. In some cases, the compositions comprise fragments of a dye.

The dye is any dye that emits light to attract insects. In some cases, the dye is selected from the group consisting of acridine dyes, cyanine dyes, fluorone dyes, oxazin dyes, phenanthridine dyes, and rhodamine dyes. In some cases, the dye is selected from the group consisting of erythrosine (FD & C Red #3; E127), FD&C Red #40 (E129, Allura Red AC), FD & C Orange #2, eosin, carboxyfluorescein, fluorescein isothiocyanate, merbromin, rose bengal, members of the DyLight Fluor family, acridine orange, acridine yellow, AlexaFluor, AutoPro 375 Antifreeze/Coolant UV Dye 1, benzanthrone, bimane, bisbenzimidine, blacklight paint, brainbow, calcein, carboxyfluorescein, coumarin, DAPI, DyLight Fluor, Dark quencher, Epicocconone, ethidium bromide, Fluo, Fluorescein, Fura, GelGreen, GelRed, Green fluorescent protein, heptamethine dyes, Hoechst stain, Iminocoumarin, Indian yellow, Indo-1, Laurdan, Lucifer yellow, Luciferin, MCherry, Merocyanine, Nile blue, Nile red, Perylene, Phioxine, Phycobilin, Phycoerythrin, Pyranine, Propidium iodide, Rhodamine, RiboGreen, RoGFP, Rubrene, Stilbene, Sulforhodamine, SYBR dyes, tetraphenyl butadiene, Texas red, Titan yellow, TSQ, Umbelliferone, Violanthrone, Yellow fluorescent protein, and YOYO. In some cases, the dye is an erythrosine (FD & C Red #3; E127) dye. In some cases, the dye is a FD&C Red #40 (E129, Allura Red AC) dye, or a FD & C Orange #2 dye. In some cases, the dye is a fluorescein.

The compositions comprise at least one dye in an amount that is equal to or less than 1.0%, 0.9%, 0.8%, 0.7%, 0.6%, 0.5%, 0.4%, 0.3%, 0.2%, 0.1%, 0.05%, 0.01%, 0.0001%, 0.00001%, 0.000001%, or 0.0000001% on a dry matter basis (wt/wt). In some cases, the compositions comprise at least one dye in an amount that is equal to or greater than 1.0%, 0.9%, 0.8%, 0.7%, 0.6%, 0.5%, 0.4%, 0.3%, 0.2%, 0.1%, 0.05%, 0.01%, 0.0001%, 0.00001%, 0.000001%, or 0.0000001% on a dry matter basis (wt/wt). In some cases, the compositions comprise at least one dye in an amount that is equal to or less than 5% but greater than 1.0%, 0.9%, 0.8%, 0.7%, 0.6%, 0.5%, 0.4%, 0.3%, 0.2%, 0.1%, 0.05%, 0.01%, 0.0001%, 0.00001%, 0.000001%, or 0.0000001% on a dry matter basis (wt/wt). In some cases, the compositions comprise at least one dye is from 0.01 ppm to 1,000 ppm on a dry matter basis (wt/wt) of one or more dye.

The compositions comprise at least one dye that has an emission wavelength less than 800 nm, 750 nm, 700 nm, 650 nm, 640 nm, 630 nm, 620 nm, 610 nm, 600 nm, 590 nm, 580 nm, 570 nm, 560 nm, 550 nm, 500 nm, 450 nm, 400 nm, 350 nm, 300 nm, 250 nm, 200 nm, or 150 nanometers (nm). In some cases, the compositions comprise at least one dye that has an emission wavelength greater than 150 nm, 200 nm, 250 nm, 260 nm, 270 nm, 280 nm, 290 nm, 300 nm, 310 nm, 320 nm, 330 nm, 340 nm, 350 nm, 400 nm, 450 nm, 500 nm, 550 nm, 600 nm, 650 nm, 700 nm, 750 nm, or 800 nm. In some cases, the compositions comprise at least one dye that has an emission wavelength from 200 nm to 700 nm, 250 nm to 650 nm, or from 300 nm to 600 nm. In some cases, the compositions comprise at least one dye that has an emission wavelength from 300 nm to 600 nm. In some cases, the compositions comprise at least one dye that has an emission wavelength from 400 nm to 600 nm. In some cases, the compositions comprise at least one dye that has an emission wavelength from 200 nm to 400 nm. In some cases, the compositions comprise at least one dye that has an emission wavelength that is near to emission wavelength of ultra violet light. In some cases, the compositions comprise at least one dye that emits a light or has an emission wavelength that is visible to an insect, wherein the insect is attracted to the light or emission wavelength.

The dye is recognizable by the at least one insect. In some cases, at least one insect is more sensitive or attracted to the dye and has an enhanced attraction to the dye. In some cases, the dye retards maggot formation. In some cases, the dye retards at least one phase of maggot formation. Without being bound by any theory, retardation of maggot formation is achieved by suppressing the growth of maggots or altering development of maggots. The retardation occurs during at least one stage of maggot formation. In some cases, the maggot retarding dye is a fluorescein.

In some cases, the compositions comprise an insecticide. In some cases, the compositions do not comprise any insecticides.

In some aspects, the compositions are stabilized and have an increased shelf life. In some cases, the compositions comprise a particulate additive, a colloidal material, or both. In some aspects, the particulate additive comprises at least one metal or at least one inorganic compound and their combination thereof. Without being bound by any theory, a particulate or colloidal material as an additive stabilizes the attractant composition and increase the shelf life. As an example, at least one type of clay is added to stabilize the compositions for use of attracting, killing, maiming, startling or suppressing the flight of insects. In some cases, the incorporation of particulate materials in the compositions suppresses the emergence of maggots from the trapped flies in the deployed traps. The suppression of fly egg development or elimination of maggots reduces the risk of insect resistance to the attractants of this disclosure. In some cases, the compositions comprise at least one colloidal material, e.g. particulates. In one example, particulates or colloidal material are added to the precursor material or formulated into the attractant post fermentation.

The particulate additives for use in the compositions described herein are selected from the group consisting of a polymer clay, a ball clay, an Edgar plastic kaolin, a silicon powder, a bentonite clay, a carbon particulate, an activated carbon, a volcanic ash, a kaolinite clay, an illite clay, a medicinal clay, a zeolite, a montmorillonite and a treated saw dust. In some cases, the compositions comprise a montmorillonite and a treated saw dust. In some cases, the compositions further comprise at least one carbohydrate or a carbohydrate moiety such as glue, starch or gelatinized starch. In various cases, the composition is formulated with colloidal materials to form an emulsion or semi-solid/liquid media. In some cases, the combination of dead flies and the emulsion forms a semi-solid or a sludge layer, which forms an efficient attractant, and further attracts more insects.

The amount of clay is in a ratio of at least 1 gram of clay per 5 gallons of fermented biomass. The amount of clay is in a ratio of at least 0.5 gram of clay per 5 gallons of fermented biomass. The amount of clay is in a ratio of at least 0.5 gram of clay per 6 gallons of fermented biomass. For example, the clay is a bentonite clay.

In some cases, the clay comprises an aluminum phyllosilicate. In some cases, the clay comprises montmolillonite. In some cases, the clay comprises any one of the different types of bentonite, each named after the respective dominant element, such as potassium (K), sodium (Na), calcium (Ca), titanium (Ti), and aluminum (Al). In some cases, the clay comprises titanium dioxide. In some cases, the clay comprises an amount of titanium dioxide of at least 1 μg, 2 μg, 3 μg, 3 μg, 5 μg, 6 μg, 7 μg, 8 μg, 9 μg, 10 μg, 20 μg, 30 μg, 40 μg, 50 μg, 60 μg, 70 μg, 80 μg, 90 μg, or more. In some cases, the clay comprises titanium dioxide. In some cases, the clay comprises an amount of titanium dioxide of at most 1 μg, 2 μg, 3 μg, 3 μg, 5 μg, 6 μg, 7 μg, 8 μg, 9 μg, 10 μg, 20 μg, 30 μg, 40 μg, 50 μg, 60 μg, 70 μg, 80 μg, 90 μg, or less. In some cases, the clay is forms from weathering of volcanic ash, in the presence of water or in the absence of water. In some cases, the clay is illite clay. In some cases, the clay is kaolinite clay. In some cases, the kaolinite-dominated clay is tonstein. In some cases, the clay is associated with coal. In some cases, the clay has the empirical formula Al₂O₃4SiO₂H₂O. In some cases, the clay comprises an aluminum silicate. In some cases, the clay is ball clay. T In some cases, the clay is kaolinitic sedimentary clay. In some cases, the clay comprises 20%-80% kaolinite, 10%-25% mica, and 6%-65% quartz. In some cases, the clay comprises lignite. In some cases, the clay is fine-grained and/or plastic in nature. In some cases, the clay comprises at least 15% kaolinite, at least 8% mica and at least 4% quartz. In some cases, the clay is slows down the escape or evaporation of at least one volatile material emitted from the compositions. In some cases, the clay preserves the attractiveness of the compositions to insects for a longer time as compared to the compositions without the clay by a factor of at least 1, 1.5, 2, 4, 5, 6, 8, 10, 20, 30, 40, 50, 60, 70, 80, 90, 100 or more.

The compositions comprise an amount of particulate additives that is equal or less than 99.9%, 95%, 90%, 85%, 80%, 80%, 75%, 70%, 65%, 60%, 55%, 50%, 45%, 40%, 35%, 30%, 25%, 20%, 15%, 10%, 5%, 4%, 3%, 2%, 1%, 0.5%, or 0.1% on a dry matter basis (wt/wt). The compositions comprises an amount of particulate additives that is equal to or greater than 99.9%, 95%, 90%, 85%, 80%, 80%, 75%, 70%, 65%, 60%, 55%, 50%, 45%, 40%, 35%, 30%, 25%, 20%, 15%, 10%, 5%, 4%, 3%, 2%, 1%, 0.5%, or 0.1% on a dry matter basis (wt/wt). The attractant comprises an amount of particulate additives that is equal to or greater than 10%, 5%, 4%, 3%, 2%, 1%, 0.5%, or 0.1% and less than 99.9%, 95%, 90%, 85%, 80%, 80%, 75%, 70%, 65%, 60%, 55%, 50%, 45%, 40%, 35%, 30%, 25%, or 20% on a dry matter basis (wt/wt). The compositions comprise an amount of particulate additives range from 0.001% to 20% or 1% to 10% on a dry matter basis (wt/wt). Sometimes the particle size of the particulate material is greater than 5 millimeters. Sometimes the particulate material size is equal to or less than 5 mm, equal to or less than 0.5 mm, equal to or less than 100 microns, equal to or less than 10 microns, equal to or less than 1 micron, equal to or less than 0.1 micron. In some cases, the particle size of the particulate material ranges between 0.5 to 100 nm. The particulate material comprises nano-particles. In some cases, the particulate material comprise a spherical particles, non-spherical particles, ordered particles, disordered particles, magnetic particles, non-magnetic particles, particles with a magnetic dipole, material or materials, particles with self-assembly capabilities, charged particles, uncharged particles, colored particles, uncolored particles, and combinations thereof.

The particulate matter comprises a clay, a silicate, or any other material that has an absorbing capacity (e.g. a hygroscopic material). The hygroscopic material is a silica, a magnesium sulfate, a calcium chloride, a molecular sieve, or any other hygroscopic material known in the art. In some cases, the particulate matter is a porous material.

In some cases, the clay improves performance of the attractant. For example, the clay increases the insect capture rate of the attractant, and extends the time of high insect capture rate when compared to the attractant without the clay. As a non-limiting example, the improvement is quantified by time, such as by seconds, minutes, hours, days, weeks, months, or years. In some cases, the clay increases the insect capture rate of the attractant by days or weeks. In some cases, the clay increases the stability of the attractant by 1 day, 2 days, 3 days, 4 days, 5 days, 6 days, 7 days, 8 days, 9 days, 10 days, or more. In some cases, the clay increases the stability of the attractant by 1 week, 2 weeks, 3 weeks, 4 weeks, 5 weeks, 6 weeks, 7 weeks, 8 weeks, 9 weeks, 10 weeks, or more. In some cases, the clay extends the insect capture rate of the attractant. In some cases, the clay extends the time of high insect capture rate of the attractant by days or weeks. In some cases, the clay extends the time of high capture rate of the attractant by 1 day, 2 days, 3 days, 4 days, 5 days, 6 days, 7 days, 8 days, 9 days, 10 days, or more. In some cases, the clay extends the time of high capture rate of the attractant by 1 week, 2 weeks, 3 weeks, 4 weeks, 5 weeks, 6 weeks, 7 weeks, 8 weeks, 9 weeks, 10 weeks, or more. In some cases, the clay extends the time of high capture rate of the attractant by 1 month, 2 months, 3 months, 4 months, 5 months, 6 months, 7 months, 8 months, 9 months, 10 months, or more.

In various cases, insects (e.g. flies) routinely ignore effluent formulations without clay and dye when deployed in proximity to effluent formulations with clay and dye. The advantages of adding clay is enhanced by an additional substance, e.g. at least one dye. The presence of at least one clay and at least one dye increases effectiveness of the attractant. In some case, the effect is immediate and spontaneous. In some cases, the presence of at least one clay and at least one dye allows the compositions to attract insects, e.g. flies, with minimal incubation time. For instance, the attractant with added clay and dye attract insects within hours, minutes, seconds, milliseconds, or shorter.

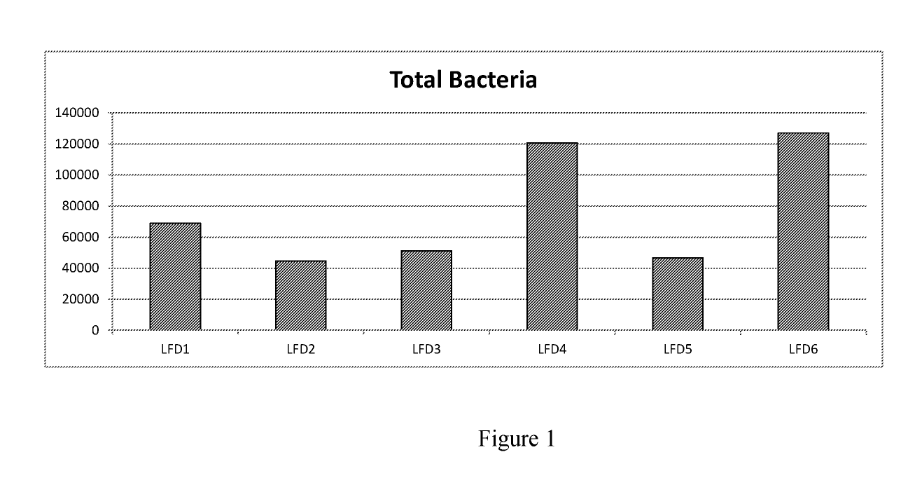

In some cases, the compositions comprising at least one clay and at least one dye that facilitates fermentation of a biomass in the presence of a bacterium (Example 1, FIGS. 1 to 3). In some cases, fermentation of a biomass is facilitated as it reduces the duration of time need for complete fermentation. In some case, the time is reduced by at least 1 day, 2 days, 3 days, 4 days, 5 days, 6 days, 7 days, 8 days, 9 days, 10 days, 1 week, 2 weeks, 3 weeks, 4 weeks, 5 weeks, 6 weeks, 7 weeks, 8 weeks, 9 weeks, 10 weeks, 1 month, 2 months, 3 months, 4 months, 5 months, 6 months, 7 months, 8 months, 9 months, 10 months, 1 year, 2 years, 3 years, 4 years, 5 years, 6 years, 7 years, 8 years, 9 years, 10 years, or more.

In some aspects, the compositions comprise at least one preservative. In some aspects, the compositions comprise no preservative. Addition of at least one clay and at least one dye increases the effectiveness of the attractant or provides preservation to the compositions. For instance, the effectiveness of attraction to insects, e.g. flies, is increased by milliseconds, seconds, minutes, hours, days, months, or years in the presence of at least one clay, at least one dye and at least one preservative. As an another example, addition of at least one clay, at least one dye and at least one preservative increase the effectiveness of the attractant within 30 seconds, 20 seconds, 15 seconds, 10 seconds, 9 seconds, 8 seconds, 7 seconds, 6 seconds, 5 seconds, 4 seconds, 3 seconds, 2 seconds, 1 second, or less. In some cases, the increase of effectiveness is within days. In some cases, the increase of effectiveness is within 30 days, 20 days, 15 days, 10 days, 9 days, 8 days, 7 days, 6 days, 5 days, 4 days, 3 days, 2 days, 1 day, or less.

In some embodiments, the presence of at least one clay and at least one dye allows the attractant to attract insects, e.g. flies, with minimal incubation time. In some cases, the attraction is instant. In some cases, presence of at least one clay and at least one dye minimizes the incubation time for the compositions to be effective in attracting an inset, e.g. a fly. For example, the incubation time is reduced by milliseconds, seconds, minutes, hours, days, months, years, 1 day, 2 days, 3 days, 4 days, 5 days, 6 days, 7 days, 8 days, 9 days, 10 days, 1 week, 2 weeks, 3 weeks, 4 weeks, 5 weeks, 6 weeks, 7 weeks, 8 weeks, 9 weeks, or 10 weeks.

After the completion of the synthesis of the compositions, the attractant is formulated. Typically, formulation increases or improves the chemical stability, physical stability, overall effectiveness, duration of effectiveness, appearance, packaged density, shelf life, and aroma of the compositions. The formulated compositions is dehydrated or freeze dried to prolong shelf life and later be reconstituted with water and other known materials for field deployment. The dried attractant is used as such, or in a humid environment. The humid environment has 5%, 10%, 20%, 30%, 40%, 50%, 60%, 70%, 80%, 90% or 100% relative humidity. In some cases, the compositions comprises 5%, 10%, 20%, 30%, 40%, 50%, 60%, 70%, 80%, 90% or 100% humidity (i.e. water). The pH of the attractant is e controlled and stabilized as needed by methods known in the art (i.e. addition of a pH buffer) to a pH equal to or less than 11, 10, 9, 8, 7, 6, 5, 4, or 3. The pH of the attractant is controlled and stabilized to a pH equal to or greater than 10, 9, 8, 7, 6, 5, 4, 3, or 2. The pH is controlled and stabilized to a pH between 2 to 10. The pH is controlled and stabilized to a pH between 5 to 9. The attractant formulation comprises addition of physical components to change the structure, characteristics, color, or appearance of the attractant compositions. Non-limiting examples of physical components include carbohydrate or carbohydrate moieties, additional particulate materials, treated saw dust, colloidal materials, clay, clays or combination of various clays, activated and non-activated charcoal, and resinous materials such as gums (i.e. guar or xanthan gum). In some cases, the attractant formulation comprises addition of yeast, a fluorescent dye, or a particulate material. In some cases, the attractant formulation comprises one or more surfactants or gelling agent. In some cases, the attractant formulation comprises up to 5% of a surfactant or gelling agent composition (wt/wt). In some cases, the attractant formulation comprises a surfactant or a gelling agent composition between 20 ppm to 5000 ppm. In some cases, the attractant formulation comprises a biodegradable surfactant. The gelling agent is a biodegradable gelling agent.

The attractant is stabilized and able to maintain effectiveness in attracting, killing, or suppressing various species of insects. The attractant is stabilized and able to attract an insect after for at least a week. The attractant is stabilized and able to attract an insect after for at least two weeks. The attractant is stabilized and able to attract an insect after for at least a month.

In some embodiments, the present disclosure provides for systems and methods for attracting at least one insect utilizing a composition comprising a fermented biomass, a dye, and a clay, and an anaerobic bacterium. The systems comprise inserting the composition into a vessel or a container. The vessel comprises a) a container capable of containing the composition; b) an opening allowing escape of the volatile materials; c) an inlet allowing flow of the composition into the container, and d) an outlet allowing flow of the composition out of the container.

Systems for the effective suppression of a population of certain insect species are constructed from a container and the attractant described herein. The container is an open container or a container with an opening or aperture through which the insects can enter the container. The dimensions of the jar are important for the effectiveness of the trap. An effective container should be large enough to hold a quantity of attractant compositions sufficient to attract the desired insects, and be large enough to hold the insects to be trapped and killed. Similarly, in some cases, an effective container is small enough to be transported and deployed in the area which it is desired to suppress the at least one insect.

The container is configured to be of a certain dimension. In some cases, the container has an interior volume of at least 100 mL, 200 mL, 300 mL, 400 mL, 500 mL, 600 mL, 700 mL, 800 mL, 900 mL, 1000 mL, 1500 mL, 2000 mL, 2500 mL, 3000 mL, 4000 mL or 100000 mL. The container may have an interior volume of less than 60000 mL, 5000 mL, 4000 mL, 3000 mL, 2000 mL, 1000 mL, 900 mL, 800 mL, 700 mL, 600 mL, 500 mL, 400 mL, 300 mL, 200 mL, or 100 mL. The container has an interior volume between (inclusive) 100-10000 mL; 200-1500 mL; or 500-1500 mL. The container is configured to be filled up to at least 5%, 10%, 15%, 20%, 25%, 30%, 35%, 40%, 45%, 50%, 55%, 60%, 65%, 70%, 75%, 80%, 85%, 90%, 95%, or 99.9% of its interior volume with the attractant. The container is configured to be filled up to less than 5%, 10%, 15%, 20%, 25%, 30%, 35%, 40%, 45%, 50%, 55%, 60%, 65%, 70%, 75%, 80%, 85%, 90%, 95%, or 99.9% of its interior volume with the attractant. The container is configured to hold at least 100, 200, 300, 400, 500, 600, 700, 800, 900, 1000 or 60000 mL of attractant. The container is at least 1, 2, 3, 4, 5, 6, 7, 8, 9, 10, 11, 12, 13, 14, 15, 16, 17, 18, 20, 22, 24, 26, 28, 30, 32, 34, 36, 38, or 100 inches tall. The container is less than 5, 6, 7, 8, 9, 10, 11, 12, 13, 14, 15, 16, 17, 18, 20, 22, 24, 26, 28, 30, 32, 34, 36, 38, 40, 44, 48, 50, 52, 56 or 100 inches tall.

The shape of the container dictates the ratio of the surface area to volume of attractant. The shape of the container is selected such that the volume of attractant is sufficient to attract enough insects into the container to completely cover the surface of the attractant. This layer of dead insects can form a barrier or seal which increases the effectiveness of the attractant. The container is cylindrical, conical, spherical, cubical, or a right rectangular prism. In some cases, the container is cylindrical. In one embodiment, the container comprises a curvilinear profile or shape.

The body of the container is coated with infra-red reflecting paint including thermal paint or paints. In some applications portions of the container is coated with infra-red reflecting paint or paints. The application of infra-red reflecting container or containers for the attractant deployment reduces the evaporation of the attractant and prolongs the longevity of the deployed fly suppression system in the field. In some cases, when evaporation of the deployed attractant has occurred, water is added to the attractant to maintain effectiveness. The active life of the deployed attractant is at least 20 days, 30 days, 40 days, 50 days, 80 days, 100 days, 130 days, 150 days or 180 days or more.

In some cases, the upper portion of the body is opaque or coated with opaque material. In some other cases, a fluorescing material is coated on the body of the container or incorporated into the structure of the container. In some cases, a pulsing or non-pulsing light emitting diode (LED) is deployed in close proximity to deployed fly suppression system. The container is configured such that the majority of insects (of the one or more species to be trapped) that have entered the container do not exit the container. This is advantageous from a pest control perspective because when no insects escape from the attractant container, the incidence of resistance is remote and less likely. The various insects of interest enter the container and are overwhelmed by the attractant and exhibit no inclination to escape from the container. The various insects of interest enter the container and are unwilling or unable to find the exit to the container. The attracted insects may die from drowning, starvation, from compounds emanating from the attractant, from unknown causes, or combinations thereof. The container is configured to create an anaerobic seal. The attracted flies die and form a layered structure over the attractant. The dead flies' structure can form an anaerobic seal and a substrate over the attractant to create a self-propagating anaerobic system. The anaerobic seal or dead fly layer structure is non-hermetic. For example, materials produced by the anaerobic action in the attractant can diffuse through the dead fly layer (anaerobic seal) or structure into the external ambient environment to attract more flies thereby creating a self-propagating open system. In some embodiments, fluids from the attractant may percolate upward through the anaerobic seal to furnish nutrients and attractants for incoming flies. The layered fly structure is semi-solid layer. The attractant fluid wets the flies and prevents their escape. The thickness of the anaerobic seal can increase as more dead flies and accumulate in the layer. The thickness of the anaerobic seal is at least 3 cm, 4 cm, 5 cm, 6 cm, 7 cm, 8 cm, 9 cm or more than 10 cm. The thickness of the anaerobic seal is between 5 cm and 100 cm (inclusive).

The attracted, trapped, killed or suppressed insects are housed in the reservoir, wherein the attractant is stored. The attracted, trapped, killed or suppressed insects are housed in a separate container from the reservoir. In various embodiments, the apparatus comprises a reservoir and a substrate housing container, wherein the substrate housing container comprises an electrical mesh or a microwave layer to kill the attracted insects. The electrical mesh or microwave layer may further comprise a wiper for cleaning the killed, dead, startled, shocked and maimed insects. In some cases, the systems further comprise an opaque pest collector for collecting the cleaning the killed, dead, startled, shocked and maimed insects. Details of descriptions are provided herein.

The systems as described herein comprise a container which holds the attractant or any of the compositions described herein. The term “systems”, the term “apparatus”, the term “trapping apparatus” are used interchangeably herein. In some cases, the systems comprise one or two additional parts, wherein the additional parts are selected from a lid and a modified cover. The attractant, container, optional lid, and modified cover are each described in herein. In some cases, the container is biodegradable. In some cases, the insect filled container is disposed in household garbage bin or recycling bin.

The trapping apparatus is opaque, semi-transparent, and/or transparent and comprise two parts, the lid and the body. For example, for large industrial application, the body is adapted with one or more apertures. The apertures are used for evacuating the dead and live flies by means of vacuum or fluid flushing arrangement, cleaning the said container and refilling the container with a fresh attractant. In some cases, the body of the apparatus is coated with thermal paint or radiation paint to reflect infrared radiation or other unwanted radiation. In some cases, the upper portion of the body is opaque or coated with opaque material. In some other cases, a fluorescing material is coated on the body of the apparatus.

The disclosed insect trap apparatus comprises at least one container for holding insect attractant. In some cases, the container is a reservoir. The apparatus further comprises a substrate housing container for holding the transferred effluent attractant from the reservoir. The apparatus further comprises at least one or more openings for the entry of attracted insects, and/or for the escape of volatile attractant vapor. Depending on the design of the apparatus, the opening is a chamber entry aperture that allows insects to fly into the chamber. In some cases, the opening is a porous mesh that allows the escape of volatile vapor but does not allow the insect to fly into the chamber. The apparatus comprises an operation system, wherein the operation system is electronically controlled to receive input from a user. In some cases, the trapping apparatus further comprises one or more additional parts, wherein the additional parts are selected from a lid, a cover, at least one sensor, a filing aperture with a cap, an insect entry aperture, a flushing aperture, a filter layer, and an electrified mesh. The attractant, container, optional lid, cover, sensor, apertures, filter layer and electrified mesh are each described in further detail herein.

The insect trap apparatus as described herein comprises at least one container for holding the insect attractant and/or mixture of attractant and attracted insects, e.g. flies. The insect trap apparatus further comprises at least one aperture for the escape of volatile attractant vapor and/or for the insect to enter the container, at least one filing aperture for the inflow of insect attractant into the apparatus, and at least one cleaning aperture for the outflow flushing out the deployed attractant and/or mixture of deployed attractant and dead flies. In some cases, the apparatus further comprises at least one adjustable sensor for controlling the inflow and outflow of effluent attractant into the container. Such process is controlled manually or by pre-programmed instructions. In some cases, the filing and the cleaning aperture are the same.

In some embodiments, the apparatus disclosed herein comprises at least one container for holding the insect attractant, and a porous mesh for the outflow of attractant vapor. The porous mesh also serves as a system for killing, startling, shocking and/or maiming the attracted insects, e.g. flies. The porous mesh is an electrified mesh that allows an electrical current to go through and kill, startle, maim, or shock the attracted flies. The porous mesh is a microwave resistant porous layer that may momentarily zap the attracted insects, e.g. flies, with microwave beam or radiation. In some cases, the apparatus further comprise a wiper for cleaning debris or dead flies on the porous mesh.

In some cases, the apparatus comprises one or two additional parts, wherein the additional parts are selected from a lid and a modified cover. The lid and/or the cover of the trapping apparatus are adapted with two or more apertures to enhance the entry rate of flies getting into the attractant apparatus. The apertures communicate between the inside of the container and the outside environment where the pest inhabits. The inner lining of the lid comprises a sealing material to prevent materials emanating from the container from leaking from the periphery of the lid. The lid is screwed to the main body of the container, and/or fastened with quick release mechanisms or other methods known in the art.

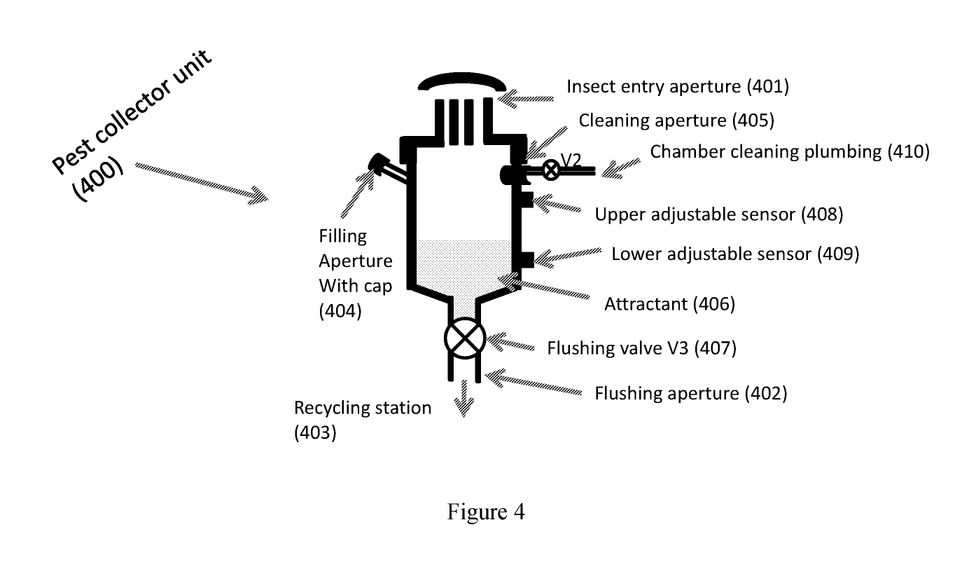

In some embodiments, the apparatus (400) is configured as in FIG. 4. The apparatus comprises at least one aperture (401) at the top portion for insects, e.g. flies, to travel therethrough, a bottom aperture flow (402) flushing out the dead insects to drain or recycling station (403), a filling aperture (404) for transferring the attractant into the apparatus and a cleaning aperture (405) for cleaning the interior of the apparatus. The filling and the cleaning aperture are the same. The flies are attracted by the effluent attractant and travel through the top portion of the apparatus immediately.

In one example, such as the apparatus (400) in FIG. 4, the formed attractant (406) is manually transferred in to the apparatus via the filling aperture (404) to a given level with the flushing valve (407) in the closed position. Effluent vapors emanates from the at least one aperture or cavity on the top portion of the apparatus to attract flies. The attracted insects die within the cavity of the apparatus, and subsequently accumulate to form an anaerobic seal or a substrate over the attractant. Materials produced by the anaerobic action in attractant diffuse through the dead fly layer or structure into the external ambient to attract more flies thereby creating a self-propagating open system. The thickness of the anaerobic seal increases as more dead flies accumulate in the layer. When the thickness of the anaerobic fly seal, for example, reach about 70% to 90% of the working volume of the flushing valve (407) is opened, with fluid (water) coming via the spray nozzles of chamber cleaning plumbing (408) flush out the dead insects of the interior of the apparatus. After cleaning the interior and exterior of the apparatus, the flushing valve V3 (407) and the chamber cleaning valve V2 (409) are closed, fresh attractant is introduced into the apparatus via the filling aperture (404), the filling aperture (404) is capped and the said apparatus is deployed to attract more insects. The attractant filling—insect capture—dead insect flushing cycle is repeated over and over to suppress insect population in the surrounding environment. In some aspects, the apparatus comprises an upper adjustable sensor (410) and a lower adjustable sensor (411).

Effective sensors for use in the present disclosure are selected from the group consisting of pH sensor, light sensor, visual sensor, conductivity sensor, turbidity sensor, viscosity sensor, pressure sensor, oxygen sensor, carbon dioxide sensor, displacement sensor, proximity sensor, and temperature sensor. The sensor is a visual sensor.

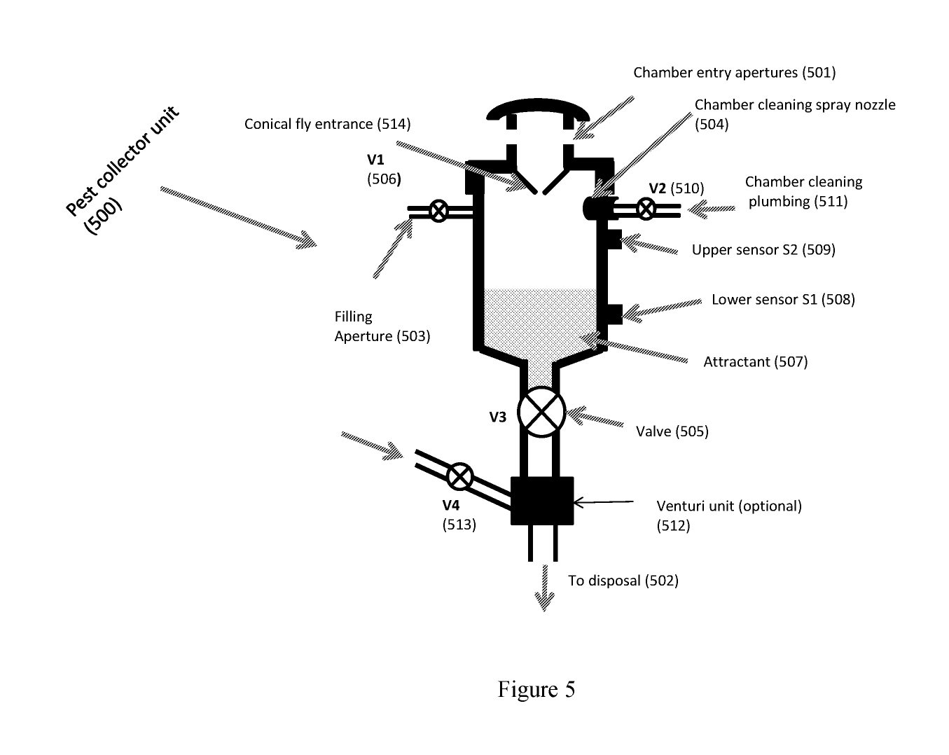

In some embodiments, the apparatus (500) is configured as in FIG. 5. The apparatus comprises at least two apertures; comprising one or more apertures at the top portion (501) for flies to enter the container, a bottom aperture flow flushing out the dead insects to drain or recycling station (502), a filling aperture (503) for transferring the attractant into the apparatus and an aperture for cleaning the interior of the apparatus (504). The filling and the cleaning aperture are the same. The apparatus in FIG. 5 comprises a remote controller (not shown) send the signal to close the flushing valve V3 (505), close and open other appropriate valves. With Valve V1 (506) open, the formed attractant (507) is transferred from a remote reservoir for example by pumping the attractant (by action of the remote controller) into the apparatus via the filling aperture (503). The adjustable lower sensor S1 (508) controls the volume of the attractant in apparatus cavity, and at the desired effluent volume the lower sensor S1 (508) sends a signal to the remote controller to shut off the remote effluent delivery means (not shown) and other appropriate inline valves, for example close valve V1 (506) to prevent the contamination of the attractant reservoir.

An effluent vapor is emanated from the at least one aperture or cavity on the top portion of the apparatus to attract flies. The attracted insects die within the cavity of the apparatus, accumulate to form an anaerobic seal or a substrate over the attractant. Materials produced by the anaerobic action in attractant diffuse through the dead fly layer or structure into the external ambient to attract more flies thereby creating a self-propagating open system The thickness of the anaerobic seal increases as more dead flies accumulate in the layer. When the thickness of the anaerobic fly seal for example reach about 85% of the working volume of the apparatus, the upper sensor S2 (509) sends a signal to the remote controller to open flushing valve V3 (505), another signal to open the chamber cleaning plumbing valve V2 (510). Water from the chamber cleaning plumbing goes via Valve 2 (510) flushes out the dead insects to an insect recycling station. In some cases, to enhance the flushing and cleaning of the interior of the apparatus, a Venturi Unit (512) is attached to portion of the disposal aperture. Forcing water through open valve V4 (513) through the Venturi Unit and the disposal line, improves chamber cleaning efficiency of interior of the pest collection unit, it also prevents insects debris fouling of the flushing valve V3 (505). In some cases, the apparatus (500) further comprises a conical fly entrance (514).

After cleaning the interior and exterior of the apparatus, the remote controller (not shown) closes the flushing valve V3 (505) and the chamber cleaning valve V2 (510), resets sensors S1 (508) and S2 (509) and other applicable sensors, fresh attractant is introduced into the apparatus via the filling aperture (503). The lower sensor S1 (508) controls the volume of the attractant in apparatus cavity, and at the desired effluent volume the lower sensor S1 (508) sends a signal to shut off the remote effluent delivery means (via the remote controller) and other appropriate inline valves, for example close valve V1 (506) to prevent the contamination of the attractant reservoir. The said apparatus is deployed to attract more insects. The attractant filling—insect capture—dead insect flushing cycle—attractant filling is repeated over and over to suppress insect population in the surrounding environment. The apparatus (500) of FIG. 5 is automated and operate with minimal manual intervention to suppress local fly population. In some embodiment, the volume of the attractant in the attractant reservoir is remotely monitored. In some cases, the volume of reservoir ranges from 1 liter to 1000 liters. In some cases, the volume of the reservoir is about 1 liter, 10 liters, 20 liters, 30 liters, 40 liters, 50 liters, 100 liters, 150 liters, 200 liters, 300 liters, 500 liters, 800 liters, 1000 liters, or more. For example the volume of reservoir ranges from 20 liters to 2000 liters. An empty reservoir is replaced with another reservoir unit with more attractant and the empty reservoir is cleaned and refilled for field deployment. In some applications the more attractant from a static or mobile source is used to recharge the near empty reservoir during routine maintenance operations.

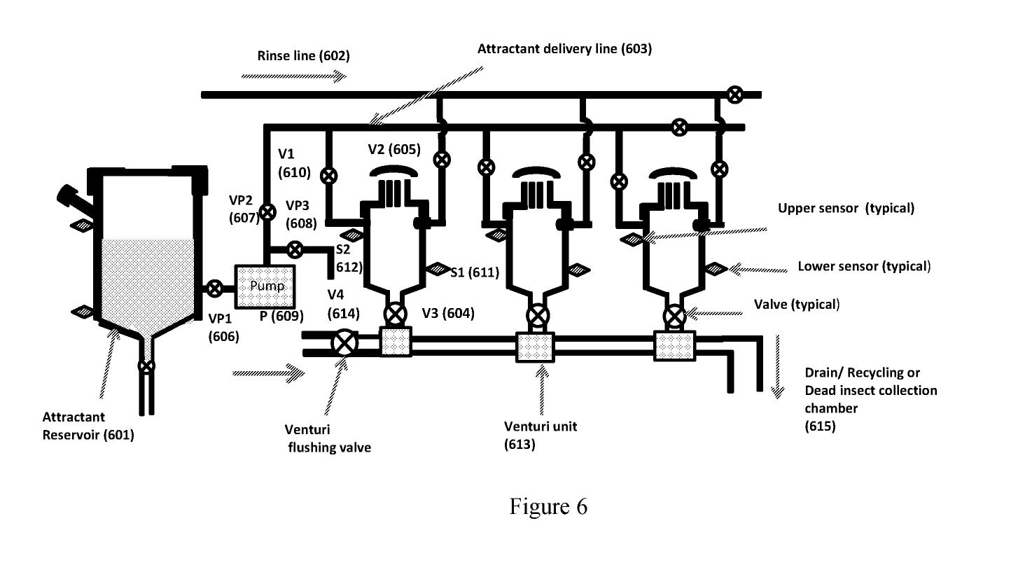

In some embodiments, the apparatus (600) is configured as in FIG. 6. This is a scaled up industrial version of the apparatus of the disclosure (400) and/or (500). In one embodiment, the pest control apparatus comprises a bulk head attractant reservoir (601), one or more plumbing pipes (602, 603), multiple valves (604-608, 610, 614), sensors (610, 611), one or more pumps (609), one or more Venturi unit (612), a remote controller (not shown) amongst other. In some applications, the apparatus of FIG. 6 (600) comprises pest collection units, are coupled in series to form an automated insect or fly collection station. In some cases, each collection station comprises at least two or more pest collection units. Multiple collection stations are fed with attractant from one or more bulk head reservoir (601).

The multiple collections stations are piped serially or in parallel with respect to any given bulk reservoir unit. In some applications, for example, the remote controller unit triggers a signal to close all the various flushing valves V3 (604) and chamber cleaning valves V2 (605). It then sends a signal to open valves VP1 (606) and VP2 (607), closing valve VP3 (608), it initiates the pump P (609) attached to the reservoir to start filling the fly collection units of interest coupled to the pump (609).

With Valves V1 (610) open, the formed attractant is transferred from a remote reservoir for example by pumping the attractant (by action of the remote controller) into the apparatus via the filling aperture. The adjustable lower sensor S1 (611) controls the volume of the attractant in apparatus cavity, and at the desired effluent volume the lower sensor S1 (611) sends a signal to the remote controller to close valve V1 (610), and when all the various pest collection units contains enough attractant, shuts off the remote effluent delivery. Isolating the pest collection unit with closed valve V1 (610) prevents the contamination of the attractant reservoir with insect debris, or maggots and/or other beings that is present in the trap.

Effluent vapors are emanated from the at least one aperture or cavity on the top portion of the apparatus to attract flies. The attracted insects die within the cavity of the apparatus accumulates to form an anaerobic seal or a substrate over the attractant. Materials produced by the anaerobic action in attractant diffuse through the dead fly layer or structure into the external ambient to attract more flies thereby creating a self-propagating open system The thickness of the anaerobic seal increases as more dead flies accumulate in the layer. When the thickness of the anaerobic fly seal for example reach about 85% of the working volume of the apparatus, the upper sensor S2 (612) sends a signal to the remote controller to open flushing valve V3 (604), another signal to open the chamber cleaning plumbing valve V2 (605). Water from the chamber cleaning plumbing goes via Valve 2 (605) and flushes out the dead insects to an insect recycling station. In some embodiments, to further enhance the flushing and cleaning of the interior of the apparatus, a Venturi Unit (613) is attached to portion of the disposal aperture. Forcing water momentarily for a determined amount of time through open valve V4 (614) through the Venturi Unit (613) and the disposal line, improves chamber cleaning efficiency of interior of the pest collection unit, it also prevents insects debris fouling of the flushing valve V3 (604).

The illustrated units are designed for minimal manual human intervention, typical routine maintenance is needed to refill the attractant reservoir (601) and inspect the various sensor and the sensors when required. The illustrated units are designed for automatic control by computer programs. One advantage of these units, for example, is to save the cost of labor needed to empty the full pest collection units, clean the units and manually transfer attractants to each unit before redeployment and finally collect the massive amount of dead flies for disposal. In environments with large fly population, a full pest collection unit may contain about 1 kg, 2 kg, 3 kg, 4 kg, 5 kg or more of dead flies. It also eliminates the exposure of a human to the foul smell and unsightly accumulation of dead large volume of flies.

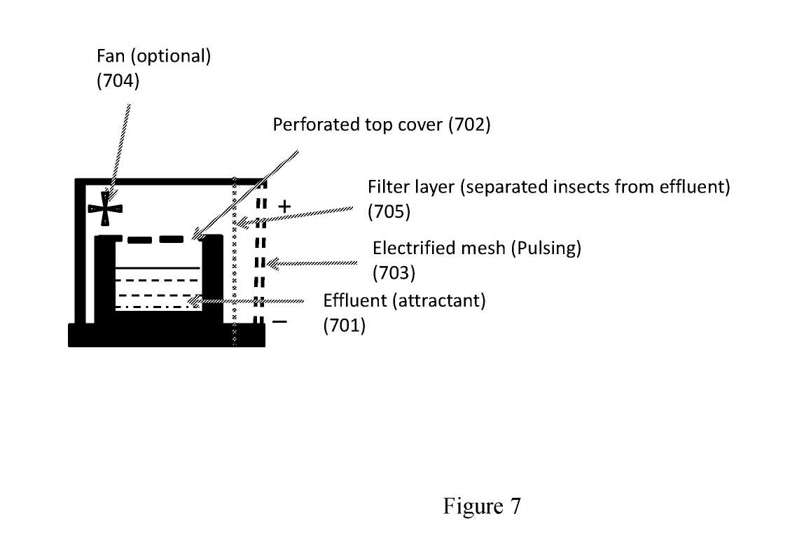

In some embodiments, the apparatus comprise arrangements where the insects are not trapped into a pest collection unit. In one case, the attracted flies are electrocuted by the powered electrical grid and in other embodiments the attracted flies are thermal degraded by a radiation means. The apparatus (700) is an illustration of an embodiment of this disclosure for electrocuting the attracted flies and is configured as in FIG. 7. The attractant effluent is housed in a container with perforated lid or top surface. Attractant effluent (701) or vapor flows out of the said housing unit via the perforated apertures (702) in the top surface, through a diffuser (705), pass the electrocuting fine mesh (703) into the ambient to attract insects. The attracted insects accumulate of the surface of the electrocuting fine mesh (703) which also acts as a barrier to the insects contaminating the effluent in the housing. At programed intervals, for example, every 20 minutes to 90 minutes a remote control unit (not shown) momentarily sends a high voltage electrical pulse (typically less than one second) through the fine mesh (703) that electrocutes all the insects perched on the fine mesh (703). The electrical mesh conducts a current of at between 100 V to 1000 V in DC or AC current (range is inclusive). The electrical mesh conducts a current of at least 250 V in DC or AC current. The electrical mesh conducts a current of 2000 V in DC or AC current. The voltage source comprise an energy storage unit for example a battery or a capacitor or from any power supply unit (e.g. line, solar etc.). An optional ventilation mechanism such as a fan (704) is activated momentarily by the remote controller to blow of flies that is stuck to the electrified surface. The fan (704) also serves to disperse the effluent vapors into the ambient environment to attract more flies.

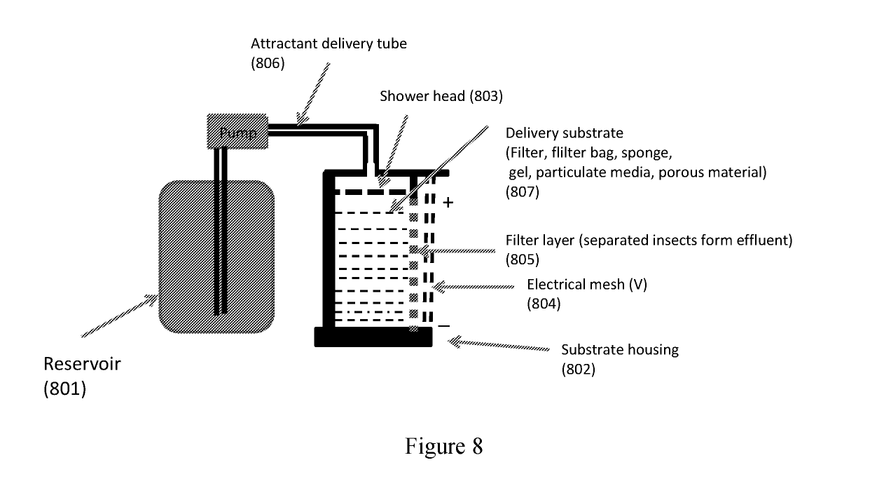

In some embodiments of present disclosure, the pest management apparatus is connected to a reservoir of effluent. The illustration of the apparatus (800) is configured in FIG. 8. The apparatus (800) comprises two parts: an attractant reservoir (801) and a substrate housing (802). The substrate housing (802) further comprises a shower head (803) on the top portion of the apparatus, an electrical mesh (804) for electrocuting the attracted insects, a filter layer (805) that separates the effluent and the electrocuting fine mesh (804). The filter layer (805) may also serves to diffuse the effluent vapor across the surface of the electrical mesh (804) more uniformly. The effluent is manually transferred or automatically controlled by a remote controller. For example, the apparatus (800) may further comprise a remote controller that sends signal to the pump to the attractant effluent to the substrate housing (802). The amount of effluent attractant is at least about 0.001 liters to 1000 liters, 0.1 liters to 1 liter, 0.5 liters to 5 liters, 2 liters to 10 liters, 8 liters to 80 liters, 50 liters to 200 liters, 100 liters to 500 liters, 200 liters to 900 liters. The amount of effluent attractant is at least about 0.001 liters, 0.1 liters, 1 liter, 2 liters, 3 liters, 4 liters, 5 liters, 6 liters, 7 liters, 8 liters, 9 liters, 10 liters, 20 liters, 50, liters, 100 liters, 200 liters, 500 liters, 1000 liters, or more. The amount of effluent attractant is about 2 liters. As a non-limiting example, the attractant effluent is transferred from the reservoir (801) to the substrate housing (802) through a pump and the attractant delivery tube (806) and the shower head (804). The attractant effluent vapors emanate from the delivery substrate (807) or the filter layer (805) to attract insects. Materials for the making of delivery substrate comprise a filter, a filter bag, sponge, gel, particulate media, porous materials, or combinations thereof.

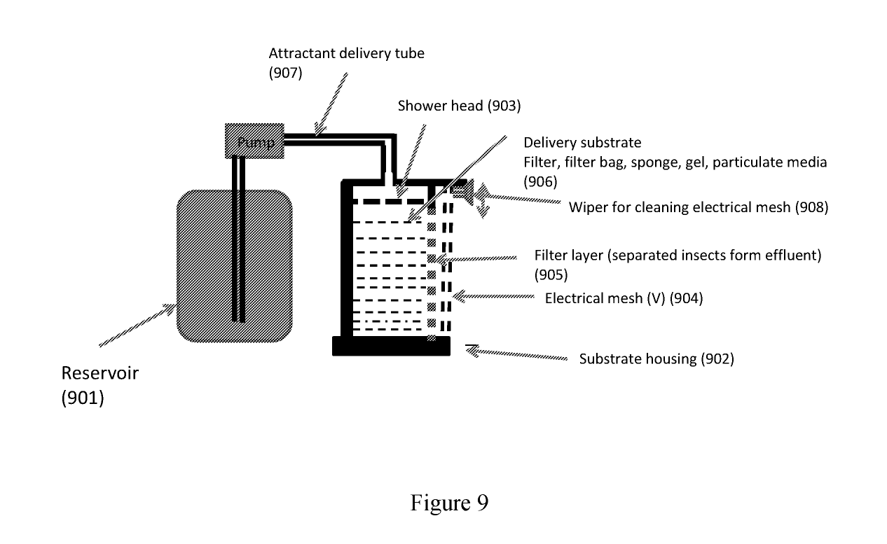

In some embodiments, the apparatus (800) further comprise a wipe (908) for cleaning electrical mesh, as illustrated in FIG. 9. The wiper unit is coupled with the electrical mesh (904). The wiper unit may further comprise insulated bristles to clean the surface of the electrocuting screen or the electrical mesh (904). The wiper unit is motorized and sweeps across the electrocuting surface (904) at set intervals to remove dead insects stuck of the surface of the said screen. The motorized wiper unit sweeps across the electrical mesh (904) between (inclusive ranges) about every 0.01 hours to 100 hours, 0.5 hours to 2 hours, 1 hour to 5 hours, 3 hours to 10 hours, 5 hours to 20 hours, 50 hours to 80 hours, or 70 hours to 90 hours. The motorized wiper unit can sweep across the electrical mesh (904) at about every 0.01 hours, 0.1 hours, 0.5 hours, 1 hour, 2 hours, 3 hours, 4 hours, 5 hours, 6 hours, 7 hours, 8 hours, 9 hours, 10 hours, 15 hours, 20 hours, 30 hours, 50 hours, 100 hours, or more. In some cases, the surface of the electrical mesh (904) is manually cleaned with polymeric or metallic brush or bristle during routine maintenance.

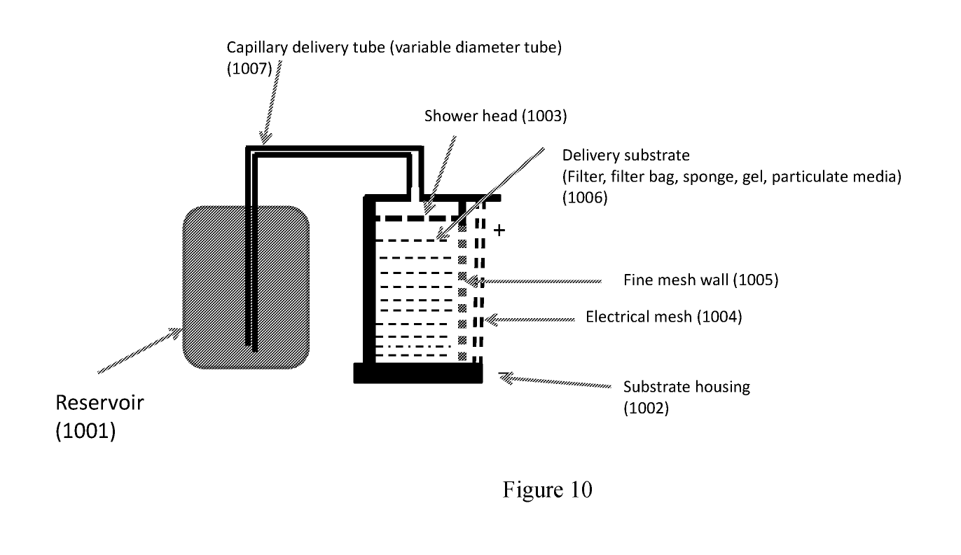

In some cases, the apparatus (800) further comprises at least one capillary tube (1007) with variable diameter tube for delivery the attractant effluent to the substrate housing (1002). The illustration of the apparatus (1000), which is a modified version of the apparatus (800), is configured in FIG. 10.

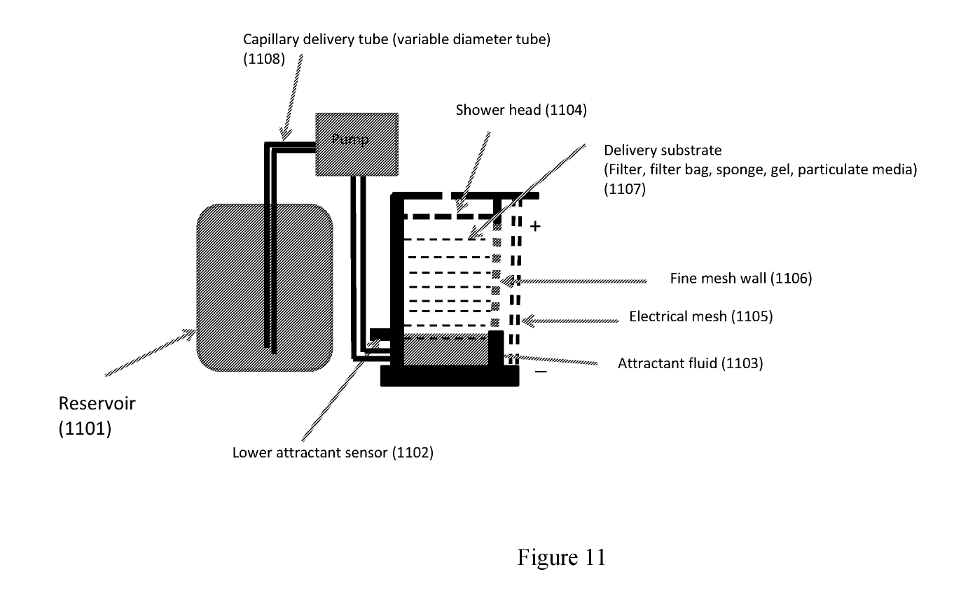

In some embodiments, the automated pest management apparatus (1100) comprises a lower attractant sensor (1102) to maintain the amount of attractant fluid (1103) in the housing. The apparatus (1100) is configured in FIG. 11, and is a modified version of the apparatus (1000) in FIG. 10. In one example, the attract effluent is transferred from the reservoir, through the pump and the capillary delivery tube (1108), to the lower portion of the housing. The lower attractant sensor (1102) detects the level of attractant effluent and sends a signal to the remote controller (not shown). The remote controller sends signal to a pump to transfer some known volume of effluent solution to maintain the amount of effluent solution in the housing. The amount of attractant effluent maintained in the housing is between 0.001 liters to 1000 liters (inclusive). The amount of effluent attractant maintained in the housing is about 0.001 liters, 0.1 liters, 1 liter, 2 liters, 3 liters, 4 liters, 5 liters, 6 liters, 7 liters, 8 liters, 9 liters, 10 liters, 20 liters, 50, liters, 100 liters, 200 liters, 500 liters, 1000 liters, or more. The amount of effluent attractant maintained in the housing is about 2 liters.

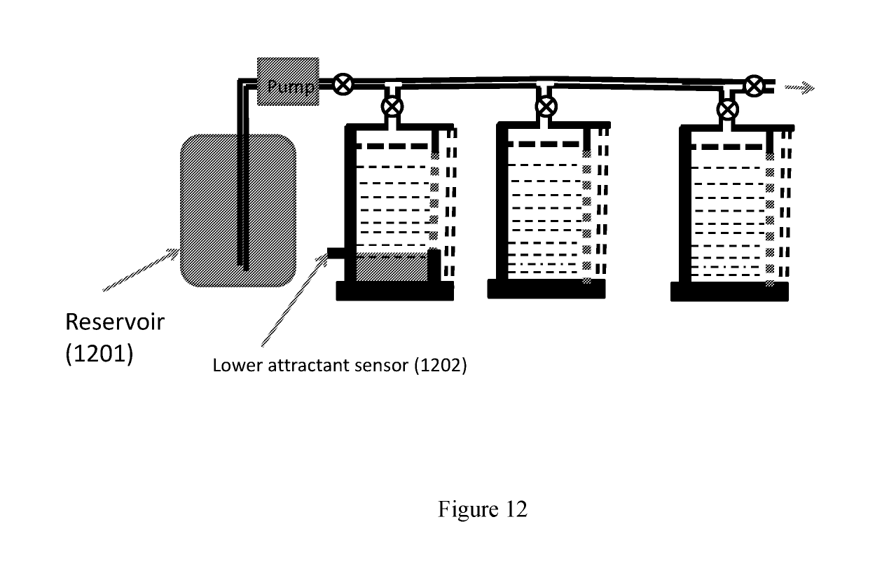

Multiple insect attractant/electrocuting units are assembled with respect to each other to form a cell as configured in FIG. 12 (1200). This is a scaled up version of the apparatus (1100) in FIG. 11. Each cell or area comprises two or more vertical or horizontal or staggered units. In some cases, the various arrays are deployed in an environment bearing copious amount of flies. The electrocuted flies fall on the ground and are scattered. In some cases, the electrocuted flies are harvested for recycling as a fodder. The deployed pest stations may operate with minimal human intervention. The deployed pest stations are automatically controlled by computer programs in some cases.

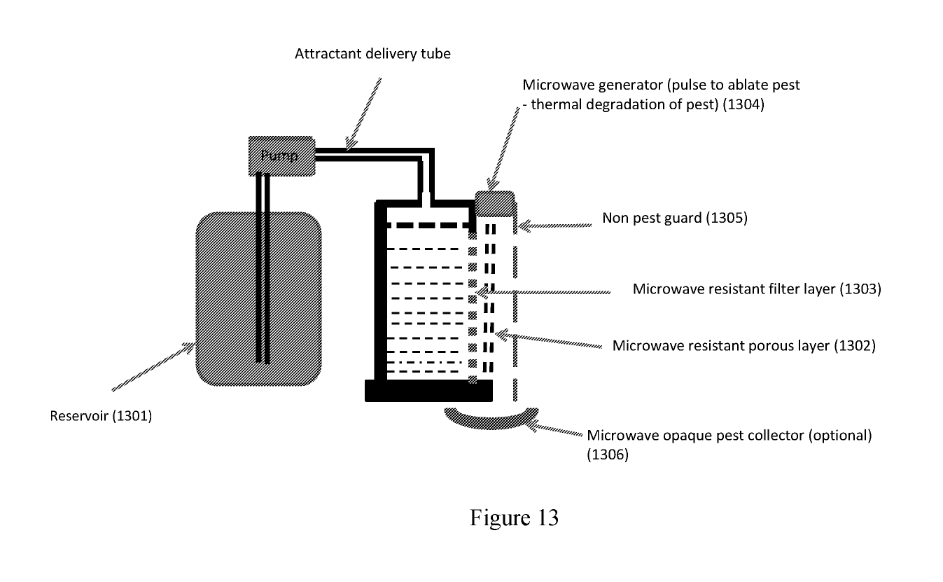

Other than electrocuting the attracted insects, the attracted insects perching on the microwave resistant porous layer is killed by momentarily zapping the flies with microwave beam or radiation. The microwave pest ablator (1300) is configured in FIG. 13. The effluent in the reservoir (1301) is transferred into a porous layer (1302) in the effluence housing unit in a controlled manner. The vapor from the effluent goes via the microwave resistance filter layer (1303) and the microwave resistant porous surface or layer (1302) to the ambient to attract insects. The attracted insects perch and accumulate over the microwave resistant porous layer (1303). After some preset intervals microwave radiation from a microwave source (1304) pulses momentarily to kill the accumulated insects by thermal degradation. The time interval for microwave radiation is from about 0.001 minute to 1000 minutes, 1 minute to 100 minutes, 10 minutes to 50 minutes, 30 minutes to 300 minutes, 50 minutes to 500 minutes, 100 minutes to 500 minutes. The time interval for microwave radiation is from about 10 minutes to 30 minutes. The fly or other pest tissue contains moisture or polar compounds which are responsive to microwave radiation. The microwave radiations generated by a compact magnetron pass through the exposed insects, create dielectric heating within the insects and the radiated insects quickly die from hyperthermia or are ablated. The compact microwave generator source typically generates less than or equal to 100 watt to thermally degrade the flies. The practical power needed is from about 0.01 watt to 100 watt, 0.1 watt to 2 watt, 1 watt to 5 watt, 3 watt to 10 watt, 8 watt to 20 watt, 15 watt to 50 watt, 25 watt to 75 watt, or 60 watt to 90 watt. The practical power needed is at least about 0.01 watt, 0.1 watt, 1 watt, 2 watt, 3 watt, 4 watt, 5 watt, 6 watt, 7 watt, 8 watt, 9 watt, 10 watt, 15 watt, 20 watt, 25 watt, 30 watt, 40 watt, 50 watt, 60 watt, 70 watt, 80 watt, 90 watt, 100 watt or more. The practical power needed is less than about 0.01 watt, less than about 0.1 watt, less than about 1 watt, less than about 2 less than about watt, less than about 3 watt, less than about 4 watt, less than about 5 watt, less than about 6 watt, less than about 7 watt, less than about 8 watt, less than about 9 watt, less than about 10 watt, less than about 15 watt, less than about 20 watt, less than about 25 watt, less than about 30 watt, less than about 40 watt, less than about 50 watt, less than about 60 watt, less than about 70 watt, less than about 80 watt, less than about 90 watt, or less than about 100 watt. In some embodiment, the practical power needed ranges from 5 watt to 90 watts (inclusive). In one embodiment the magnetron power source (1304) is set to ablate the wings of the flies. The wingless or maimed insects fall off the porous layer and eaten by other animals. To prevent injury to non-pest animals, a non-pest guard or screen (1305) is disposed in front of the porous layer. The dead flies are collected for recycling. The microwave pest ablator may comprise a microwave opaque pest collector (1306). In some embodiments, after separation of the effluent, the residue substrate is collected, washed, pastured with UV radiation and dehydrated. The dehydrated substrate is consumed by other animals and in other applications used as a fishing bait or lure. In one embodiment of this disclosure, after the separation of the effluent the residue substrate is subjected to process additional effluent material. Additional fermentation steps are performed to consume the remaining substrate material. In another embodiment, fresh biomass material is admixed with the residue substrate and fermented.

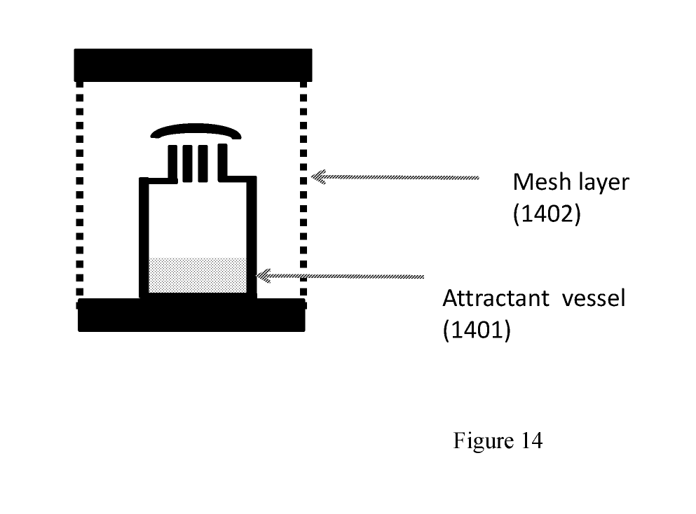

As another non-limiting example, a system for attracting one or more insects comprising one or more vessels (1400) is configured in FIG. 14. In this system, each of the one or more vessels comprising a container capable of containing the composition of fermented biomass, known as insect attractant (1401) described herein. The one or more vessels may further comprise an opening for allowing escape of the volatile material emitting from the insect attractant. The one or more vessels may surrounded by a layer of electric mesh (1402). In general, the electric mesh serves as a barrier for guarding the opening of the attractant container where the volatile material of the attractant is stored. The electric mesh is directly attached to the opening through which the volatile material can escape to the atmosphere. Typically, the electric mesh may conduct a current that is able to startle the one or more insects, temporarily shocks the one or more insects to render them unable to fly, maim the one or more insects or is able to kill the one or more insects. In some cases, a wiper is attached to the electric mesh for wiping against the electric mesh to remove or dislodge insect material from the electric mesh. The wiper is a movable brush. Operation of the wiper is set at a predetermined time. Alternatively, the wiper is controlled manually, mechanically or by a control system. In some cases, the container filling aperture valve opens momentarily to allow insects to enter the container, where the insects are trapped from escaping and eventually die and form a layer of dead flies on the surface of the insect attractant. Accumulation of the trapped and dead insects forms an anaerobic seal on the surface of the insect attractant and provides an anaerobic atmosphere in the insect attractant. In some cases, dead flies serve as nutrients for the cultured bacteria in the container such that the bacteria continue to grow and to ferment the biomass in the insect attractant.

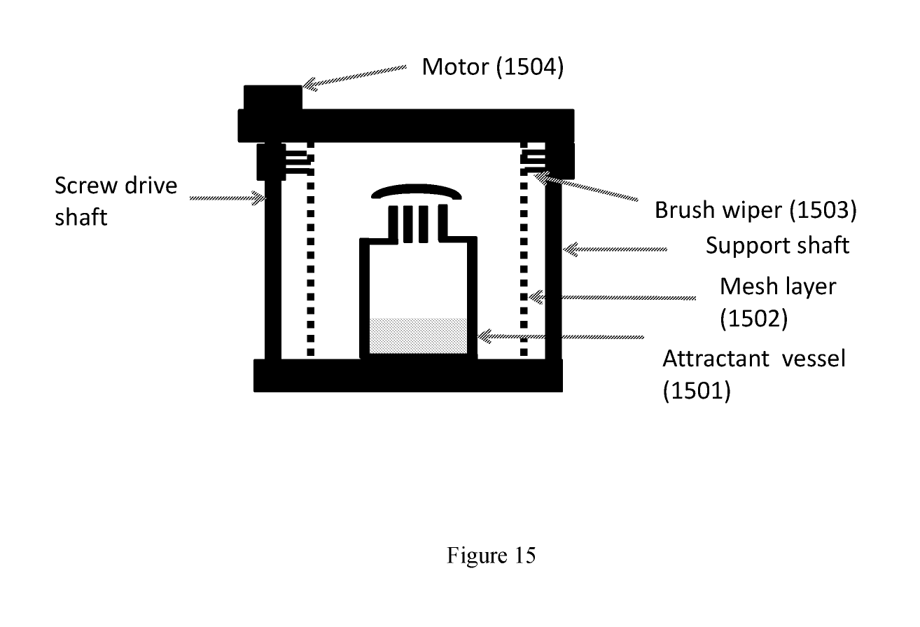

As yet another non-limiting example, a system for attracting one or more insects comprising one or more vessels (1500) is configured in FIG. 15. This is a modified version of the configuration (1400) in FIG. 14. In this system, each of the one or more vessels comprises a container capable of containing the composition of fermented biomass, known as insect attractant (1501) described herein. The one or more vessels are surrounded by a porous radiation resistance layer (1502). In general, the porous radiation resistant layer that is able to separate the one or more vessels from the surrounding environment and serves as a barrier to guard the one or more vessels from the surrounding environment. Typically, the radiation a is emitted by at least one part of the one or more vessels, wherein the radiation is able to startle the one or more insects, temporarily shocks the one or more insects to render it unable to fly, maim the one or more insects, ablate the wings or antennae of the one or more insects, thermally degrade the one or more insects or is able to kill the one or more insects. In some cases, a brush wiper (1503) is attached to the porous radiation resistant layer and is able to sweep against the porous radiation resistant layer to remove or dislodge at least a part of the one or more insects from the porous radiation resistant layer. In some cases, the brush wiper is directly attached to opening through which the volatile material can escape to the surrounding environment. The motion of the wiper is operated by the motor (1504). Operation of the wiper is set at a predetermined time. Alternatively, the motion wiper is controlled manually, mechanically or by a control system.

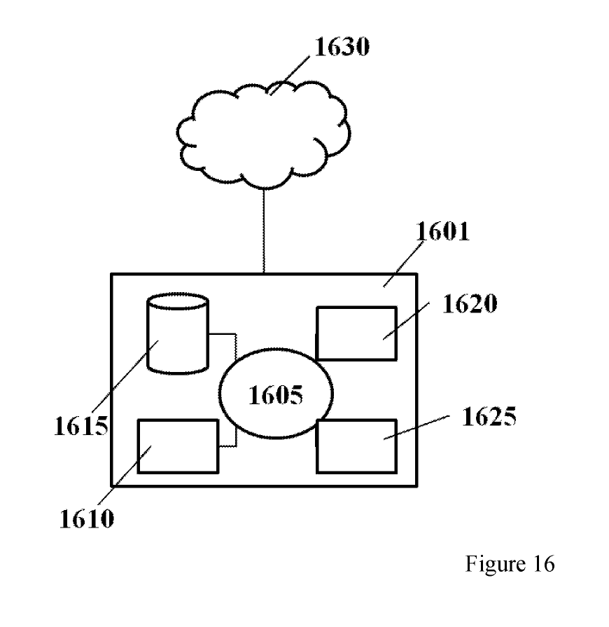

The disclosed pest management systems are optionally operated by preset computer instructions. In some cases, the computer system 1601 (FIG. 16) may include a central processing unit (CPU, also “processor” and “computer processor” herein) 1605, which is a single core or multi core processor, or a plurality of processors for parallel processing. In some cases, the computer system 1601 comprises memory or memory location (e.g., random-access memory, read-only memory, flash memory, not shown), electronic storage unit 1615 (e.g., hard disk), communication interface 1620 (e.g., network adapter) for communicating with one or more other systems, and peripheral systems 1625, such as cache, other memory, data storage and/or electronic display adapters. The memory 1618, storage unit 1615, interface 1620 and peripheral systems 1625 are in communication with the CPU 1605 through a communication bus (solid lines), such as a motherboard. The storage unit 1615 is a data storage unit (or data repository) for storing data including at least one visual sensor or at least one image sensor. The computer system 1601 is operatively coupled to a computer network (“network”) 1630 with the aid of the communication interface 1620. The network 1630 is the Internet, an internet and/or extranet, or an intranet and/or extranet that is in communication with the Internet. The network 1630 in some cases is a telecommunication and/or data network. The network 1630 can include one or more computer servers, which can enable distributed computing, such as cloud computing. The network 1630, in some cases with the aid of the computer system 1601, can implement a peer-to-peer network, which may enable systems coupled to the computer system 1601 to behave as a client or a server.

The CPU 1605 can execute a sequence of machine-readable instructions, which is embodied in a program or software. The instructions are stored in a memory location, such as the memory 1618. Examples of operations performed by the CPU 1605 can include fetch, decode, execute, and write back.

The storage unit 1615 may store files, such as drivers, libraries and saved programs. The storage unit 1615 may also store user data, e.g., user preferences and user programs. The computer system 1601 in some cases comprise one or more additional data storage units that are external to the computer system 1601, such as located on a remote server that is in communication with the computer system 1601 through an intranet or the Internet.

The computer system 1601 communicates with at least one remote computer systems through the network 1630. For instance, the computer system 1601 communicates with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled systems, Blackberry®), or personal digital assistants. The user can access the computer system 1601 via the network 1630.

Deployment of a system or systems disclosed herein, or use of a method disclosed herein suppresses an insect population in a specified environment. Non-limiting examples of environments which exhibit suppressed insect populations of one or more insect species include farmland, horse pastures, poultry pastures, grazing and non-grazing livestock ranch, slaughterhouses, meat and fish processors, dairy farms, hog farms, beaches, restaurants, homes, boats, recreational park areas, produce farms, hospitals, landfills, mushroom farms, waste management facilities, or composting.

The compositions, systems and methods described herein, comprise or serve as an attractant. The attractant is a composition that attracts one or more species of insects. Additional examples of attributes that make a composition an acceptable attractant can include specificity in attracting only desired insect species, ability to be synthesized inexpensively from organic materials, very low toxicity to humans and animals (horse, cattle birds, chicken etc.) when deployed, and low environmental toxicity of the waste products after deployment. The organically formulated attractant may not contain synthetic pesticides. Use of an attractant composition with low environmental toxicity can enable the waste material after deployment to be compostable used as a fertilizer, food for an animal such as a bird or fish.

When the deployed container is deemed sufficiently filled, the flies are removed from the container. When the deployed container is deemed sufficiently filled, the flies are removed from the container by separating the top jar from the attractant container. Alternatively, for large industrial applications, the container is adapted with one or more apertures for evacuating the dead flies by means of vacuum and refilling the container with a fresh attractant. The deployed attractant container in the cavity is deemed sufficiently filled with dead flies when at least 60%, 65%, 70%, 75%, 80%, 85%, 90%, 95%, or 99.9% of the volume of the container is full of dead flies. In some cases, the container comprises an attractant container and a separate top jar that holds at least a portion of the dead flies. The dead flies is buried, recycled or composted as seen fit. The container and the transparent jar is deployed on the ground and when the insides container is sufficiently filled with dead flies, the covering jar is separated and the dead flies are buried and disposed of according to local ordinance. The deployed container is cleaned by a built-in flushing system, wherein the flushing system is controlled manually or by pre-programed instructions. Depending on attractant formulation, the trapped, killed, startled, shocked, maimed or dead insects, such as flies may lay copious amount of eggs. The laid eggs die undeveloped and any maggot or maggots emanating from the developed laid eggs die by thermal degradation, or dehydration as moisture in the sludge in the open dishes evaporates. The dead fly mass is composted and in some applications the content of the dishes is treated with small amount of bleach prior to disposal according to local ordinance.

For the purpose of disintegrating, preserving or reducing odor emitted from the trapped, killed, startled, shocked, or dead insects, such as flies is disintegrated by thermal, chemical or mechanical treatments. The trapped, killed, startled, shocked, or dead insects are treated with heat such as electric shock or microwave beam or radiation. The trapped, killed, startled, shocked, or dead insects are treated with lyphilization such as freezing drying. The trapped, killed, startled, shocked, or dead insects is treated with chemical such as acid treatment, base treatment, chlorine, bleach, alcohol, formaldehyde, formalin, or a preserving liquid. The trapped, killed, startled, shocked, or dead insects are treated with mechanical shearing.

In one disposition of this disclosure to rapidly suppress insects, e.g. flies, in a given area, effluent or semi-solid or attractant of this disclosure is formulated for example with colloidal materials to form an emulsion or semi-solid (solid-liquid) media. The formulated media is disposed in a decomposable trap dish or trap container and placed in a dug hole in the ground. The attracted flies roll and swim in the emulsion in the container and die. The dead flies are buried by covering the dug hole with soil materials. In some instances small amount of ammonium nitrate or is added to the dead fly sludge before burial.

The following examples are intended to illustrate but not limit the disclosure. While they are typical of those that might be used, other procedures known to those skilled in the art may alternatively be used.

### Examples

### Example 1

Proportion of a population of bacteria comprising multiple bacterial

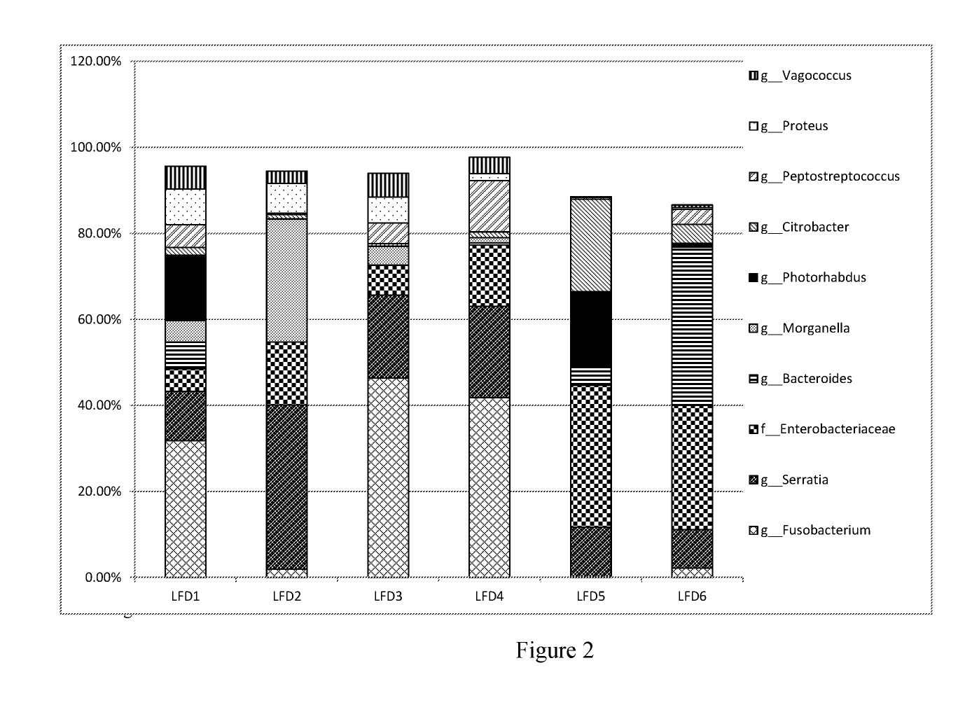

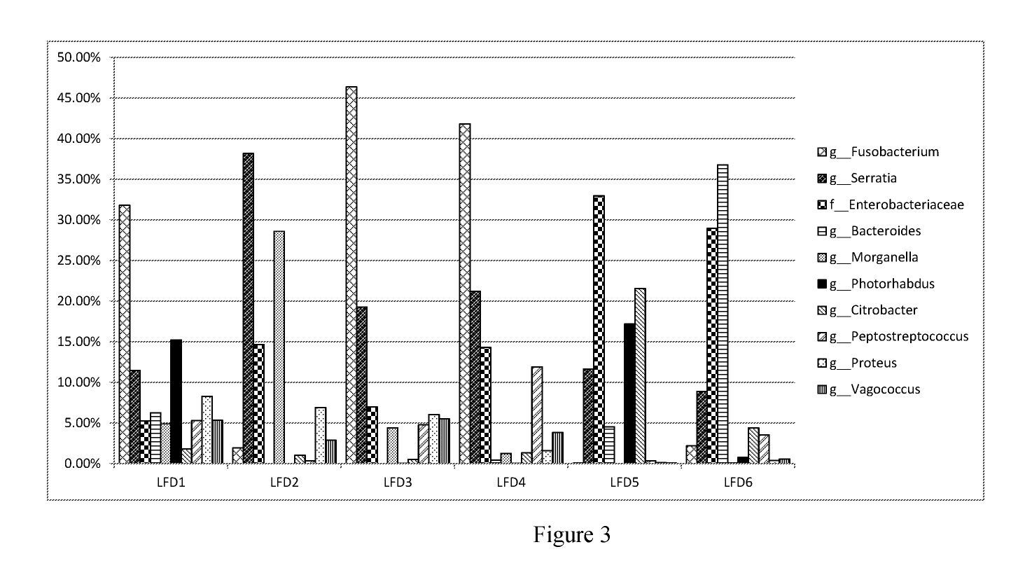

species for effective fermentation of a biomass for use of an insect attractant. A series of biomasses under varied conditions were tested (Table 1). After fermentation, the total population of bacteria (FIG. 1, Table 2) and the population of an individual bacterial species (Table 3, FIG. 2 and FIG. 3) were quantified. Bacteria examined included, Fusobacterium, Serratia, Enterobacteriaceae, Bacteroides, Photorhabdus, Citrobacter, Peptostreptococcus, Proteus, Peptoniphilus and Vagococcus.

TABLE 1
Fermentation of various biomasses under anaerobic conditions.

| | Biomass | | | |
|---|---|---|---|---|
| | (squid) | CO₂ | Clay | Dye |
| LFD1 | + | | | |
| LFD2 | + | + | | |
| LFD3 | + | + | + | |
| LFD4 | + | + | | + |
| LFD5 | + | + | + | + |
| LFD6 | + | + | + | + |

LFD1 = squid fermented by exposure to oxygen
LFD2 = squid fermented with addition of dry ice (i.e. solid carbon dioxide)
LFD3 = squid fermented with addition of dry ice (i.e. solid carbon dioxide) and bentonite clay
LFD4 = squid fermented with addition of dry ice (i.e. solid carbon dioxide) and erythrosine dye
LFD5 = squid fermented with addition of dry ice (i.e. solid carbon dioxide), bentonite clay and erythrosine dye
LFD6 = LFD5 sample after 1 month
“+” represents presence of the indicated ingredient in each squid fermented biomass.
Samples in LFD1 to LFD5 were fermented for ten (10) days.

TABLE 2
Total population of bacteria comprising multiple bacterial species detected
in various fermentation conditions.

| Samples | Total Bacteria | Process |
|---|---|---|
| LFD1 | 68921 | Naked |
| LFD2 | 44651 | CO2 only |
| LFD3 | 51141 | CO2 + Clay |
| LFD4 | 120734 | CO2 + Dye |
| LFD5 | 46645 | Comm. Sample |
| LFD6 | 127072 | Deployed Sample |

LFD1 = squid fermented by exposure to oxygen
LFD2 = squid fermented with addition of dry ice (i.e. solid carbon dioxide)
LFD3 = squid fermented with addition of dry ice (i.e. solid carbon dioxide) and bentonite clay
LFD4 = squid fermented with addition of dry ice (i.e. solid carbon dioxide) and erythrosine dye
LFD5 = squid fermented with addition of dry ice (i.e. solid carbon dioxide), bentonite clay and erythrosine dye
LFD6 = LFD5 sample after 1 month
Samples in LFD1 to LFD5 were fermented for ten (10) days.

TABLE 3
Quantification of an individual bacterial population
in a fermentation biomass under various conditions.

| Bacteria | LFD1 | LFD2 | LFD3 | LFD4 | LFD5 | LFD6 |
|---|---|---|---|---|---|---|
| g_Fusobac- | 31.80% | 1.94% | 46.37% | 41.82% | 0.07% | 2.21% |
| terium | | | | | | |
| g_Serratia | 11.46% | 38.17% | 19.27% | 21.20% | 11.65% | 8.89% |
| f_Enterobac- | 5.27% | 14.66% | 6.98% | 14.30% | 32.96% | 28.96% |
| teriaceae | | | | | | |
| g_Bacteroides | 6.27% | 0.00% | 0.02% | 0.44% | 4.54% | 36.76% |
| g_Morganella | 4.89% | 28.60% | 4.39% | 1.25% | 0.02% | 0.10% |
| g_Photo- | 15.23% | 0.00% | 0.07% | 0.04% | 17.18% | 0.78% |
| rhabdus | | | | | | |
| g_Citrobacter | 1.83% | 1.02% | 0.53% | 1.33% | 21.56% | 4.40% |
| g_Peptostrep- | 5.29% | 0.35% | 4.77% | 11.90% | 0.35% | 3.53% |
| tococcus | | | | | | |
| g_Proteus | 8.28% | 6.89% | 6.05% | 1.61% | 0.13% | 0.41% |
| g_Vagococcus | 5.33% | 2.88% | 5.51% | 3.82% | 0.09% | 0.57% |

LFD1 = squid fermented by exposure to oxygen
LFD2 = squid fermented with addition of dry ice (i.e. solid carbon dioxide)
LFD3 = squid fermented with addition of dry ice (i.e. solid carbon dioxide) and bentonite clay
LFD4 = squid fermented with addition of dry ice (i.e. solid carbon dioxide) and erythrosine dye
LFD5 = squid fermented with addition of dry ice (i.e. solid carbon dioxide), bentonite clay and erythrosine dye
LFD6 = LFD5 sample after 1 month
Samples in LFD1 to LFD5 were fermented for ten (10) days.

Example 1 demonstrates that fermentation of the squid biomass requires presence of the bacteria Morganella. As shown in Table 1, Table 3, FIG. 2 and FIG. 3, the amount of Morganella reduced as the fermentation progressed, suggesting that the fermentation involves consumption of Morganella. Furthermore, addition of CO₂ and a clay or a dye facilitated the consumption of Morganella and the fermentation process (LFD3 and LFD4). The effect was enhanced in the presence of both a clay and a dye in combination with CO₂ (LFD5 and LFD6).

### Example 2

Efficiency of Various Fermented Biomasses in Attracting an Insect.

The following experiment tests the efficiency of a fermented biomass treated in the condition illustrated in Example 1.

A farmer purchases six fermented biomasses, namely LFD1, LFD2, LFD3, LFD4, LFD5, and LFD6, each of which is produced as described in Example 1. The farmer places an equal portion of the six fermented biomasses into six identical buckets, such that one bucket stores one type of fermented biomass. On Day 0, the farmer places the buckets in two setups: A) all six buckets are placed side by side; B) all six buckets are distributed all across the farm. The bucket is opaque and covered with a porous layer on top that allows emission of any volatile material released from the fermented biomass, and entry of insects that are attracted to the volatile material. The farmer leaves the buckets undisturbed, even during examination on Day 0, Day 1, Day 3, Day 5, Day 10, and Day 20. No additional fermented biomass is added to the bucket. During each examination, the amount of insects attracted to each bucket is record by measuring the thickness of insect layer on the surface of the fermented biomass. The measurements of thickness in each bucket on each examination day are compared and used to estimate an amount of insect attracted to the fermented biomass.

The fermented biomass comprising squid only (LFD1) does not attract a detectable amount of (e.g. a layer of insects, or a patch of insects) until Day 2. The amount of attracted insects slowly increases from Day 3 to Day 5 and dropped from Day 5 to Day 20. By Day 20, no detectable difference attracted insects is observed when compared to the amount recorded on Day 10.

The fermented biomass comprising squid, and CO₂ (LFD2) does not attract a detectable amount of insects (e.g. a layer of insects, or a patch of insects) until Day 1. The amount of attracted insects slowly increases from Day 3 to Day 10 and dropped from Day 10 to Day 20. By Day 20, no detectable difference attracted insects is observed when compared to the amount recorded on Day 10.

The fermented biomass comprising squid, CO₂, and a clay (LFD3) starts attracting insects on Day 1. The estimated amount of insects attracted increases from Day 1 through Day 10, and slows down from Day 10 to Day 20. On Day 20, LFD3 is still attracting insects in a detectable amount.

The fermented biomass comprising squid, CO₂, and a dye (LFD4) starts attracting insects on Day 0. The estimated amount of insects attracted increases from Day 0 through Day 10, and slows down from Day 10 to Day 20. On Day 20, the amount of attracted insects is relatively the same as the amount of insects recorded on Day 10.

The fermented biomass comprising squid, CO₂, a clay and a dye (LFD5 and LFD6) attracts insects within one hour on Day 0. The estimated amount of insects attracted increases from Day 0 through Day 10, and slows down from Day 10 to Day 20. On Day 20, both LFD5 and LFD6 are still attracting insects in a detectable amount. In addition, the efficiency of attracting an insect is not affected whether the fermented biomass is freshly prepared (LFD5) or deployed (LFD6).

In all regimes, the fermented biomasses attract mostly flies, e.g. house flies, horse flies, and some other insects, e.g. ants, mosquitoes. Fermented biomasses of regimes LFD5 and LFD6 attract the highest amount of insects throughout the experiment. The estimated amount of attracted insects is comparable when the different fermented biomasses are placed side by side (setup A) or in a distance (setup B). This finding suggests that the fermented biomasses LFD5 and LFD6 have superior attraction frequency over other fermented biomasses.

In summary, this experiment demonstrates that a fermented biomass attracts insects (LFD1-LFD6). The efficiency is enhanced when the fermentation occurs in an anaerobic condition (addition of CO₂, TiO₂ and clay). The efficiency is enhanced in the presence of a dye (LFD4, LFD5, and LFD6). The duration of efficiency is preserved in the presence of a clay (LFD5 and LFD6).

### Example 3

A system depicting an insect trap apparatus (FIG. 4) comprising a container, two apertures: an aperture at the top portion for insects (e.g. flies) to enter the container, and a bottom aperture flow flushing out the dead insects (e.g. flies), and two sensors.

### Example 4

A system depicting an insect trap apparatus (FIG. 5) comprising a container, two apertures: an aperture at the top portion for insects (e.g. flies) to enter the container, and a bottom aperture flow flushing out the dead insects (e.g. flies), two sensors, and a conical fly entrance.

### Example 5

A scaled up industrial version of the insect trap apparatus in Example 2 (FIG. 6).

### Example 6

A pest management system comprising a powered electrical mesh and a fan (FIG. 7).

### Example 7

A pest management system comprising a powered electrical mesh, a reservoir for storing and supplying insect attractant (FIG. 8).

### Example 8

A pest management system comprising a powered electrical mesh, a

reservoir for storing and supplying insect attractant, and an electrical mesh wiper (FIG. 9).

### Example 9

A pest management system comprising a powered electrical mesh, a reservoir for storing and supplying insect attractant, and a capillary action delivery (FIG. 10).

### Example 10

A pest management system comprising a powered electrical mesh and a reservoir for storing and supplying insect attractant, a capillary action delivery, and a sensor (FIG. 11).

### Example 11

A scaled up version of the apparatus in Example 5 (FIG. 12).

### Example 12

A microwave pest ablation system comprising a microwave resistant porous layer, a reservoir for storing and supplying insect attractant, and a microwave opaque pest collector (FIG. 13).

### Example 13

A pest management system with an electric mesh or porous radiation resistant layer literally surrounds a porous vessel containing attractant of disclosure (FIG. 14).

### Example 14

A pest management system with brush cleaner arrangement for cleaning the electric mesh layer outside the vessel containing attractant of disclosure (FIG. 15).

The preceding merely illustrates the principles of the disclosure. It will be appreciated that those skilled in the art will be able to devise various arrangements which, although not explicitly described or shown herein, embody the principles of the disclosure and are included within its spirit and scope. Furthermore, all examples and conditional language recited herein are principally intended to aid the reader in understanding the principles of the disclosure, and are to be construed as being without limitation to such specifically recited examples and conditions. Moreover, all statements herein reciting principles, cases, and cases of the disclosure as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary cases shown and described herein. Rather, the scope and spirit of the present disclosure is embodied by the appended claims.

While preferred cases of the present disclosure have been shown and described herein, it will be obvious to those skilled in the art that such cases are provided by way of example only. Numerous variations, changes, and substitutions will now occur to those skilled in the art without departing from the disclosure. It should be understood that various alternatives to the cases of the disclosure described herein is employed in practicing the disclosure. It is intended that the following claims define the scope of the disclosure and that methods and structures within the scope of these claims and their equivalents be covered thereby.

What is claimed is:

1. A composition comprising:
a. at least one fermented biomass;
b. at least one dye; and
c. at least one particulate matter;
wherein the composition emits at least one volatile material, and
wherein the volatile material attracts at least one insect.

2. The composition of claim 1, wherein the fermented biomass comprises effluent.

3. The composition of claim 1, wherein the fermented biomass comprises a biological material obtained from a cephalopod selected from subclasses Coleoidea and Nautiloidea.

4. The composition of claim 3, wherein the cephalopod is a squid.

5. The composition of claim 1, wherein the fermented biomass is subjected to at least one of oxygen depletion and carbon dioxide enrichment during fermentation.

6. The composition of claim 1, wherein the composition comprises at least one anaerobic bacterium.

7. The composition of claim 6, wherein the anaerobic bacterium occurs in a gut microbiome of an animal intestinal tract.

8. The composition of claim 6, wherein the at least one anaerobic bacterium is at least one bacterium selected from the list of bacteria clade consisting of Enterobacteriaceae, Bacteroides, Citrobacter, Peptostreptococcus, and Serratia.

9. The composition of claim 6, wherein the at least one anaerobic bacterium is at least one bacterium selected from the list of bacteria consisting of Morganella morganii and Morganella sibonii.

10. The composition of claim 1, wherein the dye is visible to the insect, and wherein the insect is attracted to the dye.

11. The composition of claim 1, wherein the dye is a photodegradable dye.

12. The composition of claim 1, wherein the dye is a biodegradable dye.

13. The composition of claim 10, wherein the dye has an emission wavelength ranging from 200 to 800 nanometers.

14. The composition of claim 10, wherein the dye has an emission wavelength ranging from 400 to 600 nanometers.

15. The composition of claim 10, wherein the dye has an emission wavelength at a near ultra violet wavelength.

16. The composition of claim 10, wherein the dye is selected from the group consisting of a food dye, fluorescein, erythrosine, eosin, carboxyfluorescein, fluorescein isothiocyanate, merbromin, rose bengal, FD&C Red#40 (E129, Allura Red AC) dye, FD&C Orange #2Dye, and a member of the DyLight fluor family.

17. The composition of claim 16, wherein the dye comprises an Erythrosine (FD&C Red#3; E127) dye.

18. The composition of claim 10, wherein the composition comprises a dye fragment.

19. The composition of claim 1, wherein the particulate matter comprises a clay.

20. The composition of claim 19, wherein the clay comprises a bentonite clay.

21. The composition of claim 1, wherein the particulate matter comprises titanium dioxide (TiO2) at an amount of at least 0.5 μg.

22. The composition of claim 1, wherein the particulate matter comprises an inorganic material.

23. The composition of claim 1, wherein the composition attracts the at least one insect from a distance of at least 500 meters.

24. The composition of claim 1, wherein the at least one insect is at least one insect selected from the group consisting of a black fly, a cluster fly, a crane fly, a robber fly, a moth fly, a fruit fly, a house fly, a horse fly, a deer fly, a face fly, a flesh fly, a green fly, a horn fly, a sand fly, a sparaerocierid fly, a yellow fly, a western cherry fruit fly, a tsetse fly, a cecid fly, a phorid fly, a sciarid fly, a stable fly, a mite, and a gnat.

25. The composition of claim 24, wherein the composition attracts the at least one insect at a first frequency of at least 50 times greater than a second frequency at which the composition attracts at least one bee.

26. A system comprising:
a. a vessel;
b. a container;
c. an opening to allow escape of a volatile material;
d. an inlet;
e. an outlet; and
f. a composition held in the container, the composition comprising at least one fermented biomass in an oxygen depleted atmosphere, at least one anaerobic bacterium, at least one dye, and at least one inorganic matter.

27. The system of claim 26, comprising an electric mesh surrounding the container.

28. The system of claim 27, comprising a porous layer that separates the container from the surrounding environment.

29. The system of claim 28, comprising a porous layer that separates the vessel from the surrounding environment.

30. The system of claim 26, wherein the container is held inside the vessel.

31. The system of claim 26, comprising an electronic control system for receiving operational instructions from a user.

32. The system of claim 26, wherein the composition comprises a dye fragment.

33. The system of any one of claims 26-32, comprising a composition of any one of claims 1-25.
